(19) United States
(12) Patent Application Publication
(10) Pub. No.: US 2026/0084798 A1
(43) Pub. Date: Mar. 26, 2026

(54) NAVIGATION AND CONTROL FOR AUTONOMOUS VESSELS

(71) Applicant: Embry-Riddle Aeronautical University, Inc., Daytona Beach, FL (US)

(72) Inventors: Darris Lynn White, Port Orange, FL (US); Eric Joe Coyle, Port Orange, FL (US); Patrick Norman Currier, Port Orange, FL (US)

(21) Appl. No.: 19/337,078

(22) Filed: Sep. 23, 2025

Related U.S. Application Data
(60) Provisional application No. 63/697,814, filed on Sep. 23, 2024.

(51) Int. Cl. B63H 25/42; B63B 79/10; B63B 79/20; B63B 79/40; B63H 25/04; G05D 1/43; G05D 107/00; G05D 109/30

(52) U.S. Cl. CPC B63H 25/42; B63B 79/10; B63B 79/20; B63B 79/40; B63H 25/04; G05D 1/43; G05D 2107/27; G05D 2109/34; G05D 2109/38

(57) ABSTRACT

Marine vessel control can include the application of surge force, sway force, and yaw moment. The present subject matter can include two aspects, including determination of forces and moments to achieve desired motion, and translation of such forces and moments into thrust and steering commands suitable for the available propulsion devices. Various operating modes can be employed to effectively control their motion. In each operating mode, feedback control can be used to determine one or more of a target surge force, sway force, or yaw moment, or combinations thereof. The feedback controller can include individual PID (or other) controllers corresponding to each degree of freedom, a state feedback controller, or other feedback control architectures. A current vessel state can be compared to the target vessel state to determine the error in position, heading, and speed. These errors can be transformed from the global coordinate system to the vessel coordinate system for determination of appropriate thrust and steering commands.

### CLAIM OF PRIORITY

This patent application claims the benefit of priority of White et al., U.S. Provisional Patent Application No. 63/697,814, titled “NAVIGATION AND CONTROL FOR AUTONOMOUS VESSELS,” filed on Sep. 23, 2024 (Attorney Docket No. 4568.023PRV), which is hereby incorporated by reference herein in its entirety.

### FIELD OF THE DISCLOSURE

This document pertains generally, but not by way of limitation, to control systems for vessels such as autonomous marine vessels, and more particularly to techniques and systems for controlling one or more of position, orientation, or velocity using multiple independently-steerable propulsion devices.

### BACKGROUND

Control of marine vessels can be achieved through various techniques. As an illustrative example, an autonomous vessel or other craft can include or use propulsion devices such as steerable thrusters or propulsors. Various challenges are associated with navigation, involving providing control inputs to direct a vessel to desired location or along a desired course between locations, and with control, such as establishing or maintaining a desired position or orientation, such as for station keeping or stabilization, maintenance of a specified course or velocity, or combinations thereof. In one approach, a vessel can provide direct operator inputs allowing control over one or more thrusters or propulsors, such as allowing manual control over propulsive torque and steering direction, as illustrative examples. Such manual control, even if implemented remotely, may not be suitable or feasible for use with unmanned vessels, and such manual control may not provide stabilization or maintenance of a desired vessel orientation across all conditions.

### SUMMARY OF THE DISCLOSURE

The present inventors have recognized, among other things, that one or more of a position, orientation, or velocity of a marine vessel can be controlled using techniques and systems as described herein, such as to provide autonomous operation of a vessel. The techniques and systems described herein are suitable for use with vessels equipped with multiple independently steered propulsion devices. As an illustration, a technique as shown herein can include receiving a command to move to, or hold, a specific position, velocity, or orientation, or combinations thereof. A position, velocity, and orientation of a vessel can be collectively referred to as the state of the vessel. Based on the commanded state and current state, the technique described herein can select an operating mode: pose control, path following, or a transitional state, as illustrative examples. Using feedback control, a control system can determine requisite forces and moment to control the motion of the vessel, such as in the surge, sway, and yaw directions. An inverse kinematic model can be used to calculate the steering angle and thrust force commands for respective propulsion devices for a set of distinct operating classes.

For example, a machine-implemented method for controlling a marine vessel using steerable thrusters can include receiving or establishing a commanded force or moment vector, determining an operating class, from amongst a plurality of operating classes based on constraint combinations of steerable thruster variables, that achieves the commanded force or moment vector, and generating thruster commands for the steerable thrusters based on the determined operating class. The commanded force or moment vector can include one or more of a surge force, a sway force, or a yaw moment for the marine vessel. An operating mode can be selected from a plurality of operating modes including a pose control mode and a path following mode, and the commanded force or moment vector based at least in part on the operating mode. Generating the thruster commands can include evaluating a closed-form inverse kinematic model corresponding to a determined operating class. The plurality of operating classes can fall within a locus of force and moment combinations defining a workspace representing achievable force and moment combinations within physical limits of steerable thruster variables. The commanded force or moment vector can be scaled when the commanded force or moment vector exceeds a workspace boundary.

In an example, a marine vessel control system for controlling a marine vessel using steerable thrusters can include a controller comprising a processor circuit and a memory circuit, the memory circuit comprising instructions that when executed by the processor circuit, cause the controller to perform one or more portions or an entirety of a machine-implemented method as mentioned in the examples above or as described elsewhere in this document.

In an example, a marine vessel can include steerable thrusters, a sensor configured to measure a current state of the marine vessel, and a controller comprising a processor circuit and a memory circuit, the memory circuit comprising instructions that when executed by the processor circuit, cause the controller to perform one or more portions or an entirety of a machine-implemented method as mentioned in the examples above or as described elsewhere in this document.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a control system scheme for control of a marine vessel.

FIG. 2A illustrates generally a set of definitions for a coordinate system used in various examples described herein

FIG. 2B illustrates generally a set of further definitions including propulsion devices, forces, and moments.

FIG. 3 shows and illustrative example of an unmanned marine vessel such as can be controlled using the techniques described in this document.

FIG. 4A shows an example comprising a high-level flowchart that can describe a technique, such as a machine implemented method, for performing marine vessel control according to various examples in this document.

FIG. 4B shows an illustrative example comprising a flowchart that can describe a technique, such as a machine implemented method, for performing mode selection for marine vessel control according to various examples in this document.

FIG. 5 shows an illustrative example comprising a “workspace” defined as a locus of force and moment combinations addressable by a marine vessel control technique.

FIG. 6A shows an illustrative example comprising a “workspace” separated by class definition and limiting thrust.

FIG. 6B shows another illustrative example comprising a “workspace” separated by class definition and limiting thrust.

FIG. 7A shows an illustrative example comprising a flowchart for establishing an operating class with a specified force/moment vector, including three branches.

FIG. 7B shows an illustrative example comprising a flowchart corresponding to Branch 1 of the flowchart of FIG. 7A.

FIG. 7C shows an illustrative example comprising a flowchart corresponding to Branch 2 of the flowchart of FIG. 7A.

FIG. 7D shows an illustrative example comprising a flowchart corresponding to Branch 3 of the flowchart of FIG. 7A.

FIG. 8 shows an illustrative example comprising a flowchart for establishing a thrust limit on a surface of a workspace, such as the workspace shown illustratively in FIG. 6B.

FIG. 9 shows an illustrative example comprising a subspace of the “workspace” of FIG. 6B, corresponding to “Class 1.”

FIG. 10 shows an illustrative example comprising a subspace of the “workspace” of FIG. 6B, corresponding to “Class 2.”

FIG. 11 shows an illustrative example comprising a subspace of the “workspace” of FIG. 6B, corresponding to “Class 3.”

FIG. 12 shows an illustrative example comprising a subspace of the “workspace” of FIG. 6B, corresponding to “Class 4.”

FIG. 13 shows an illustrative example comprising a subspace of the “workspace” of FIG. 6B, corresponding to “Class 5.”

FIG. 14 illustrates generally a set of definitions showing propulsion devices, thrust magnitudes, and thrust angles associated with a parallel steer class definition.

FIG. 15 shows an illustrative example comprising a subspace of the “workspace” of FIG. 6B, corresponding to “Class 6.”

FIG. 16 illustrates generally a set of definitions showing propulsion devices, thrust magnitudes, and thrust angles associated with a counter steer class definition.

FIG. 17 shows an illustrative example comprising a subspace of the “workspace” of FIG. 6B, corresponding to “Class 7.”

FIG. 18 shows an illustrative example comprising a subspace of the “workspace” of FIG. 6B, corresponding to “Class 8.”

FIG. 19 shows an illustrative example comprising a subspace of the “workspace” of FIG. 6B, corresponding to “Class 9.”

FIG. 20 shows an illustrative example comprising a subspace of the “workspace” of FIG. 6B, corresponding to “Class 10.”

FIG. 21 illustrates generally a technique, such a machine implemented method, for performing marine vessel control.

FIG. 22 illustrates a block diagram of an example comprising a machine upon which any one or more of the techniques (e.g., methodologies) discussed herein may be performed.

### DETAILED DESCRIPTION

A position, velocity, and orientation of a vessel can be collectively referred to as the state of the vessel. Based on the commanded state and current state, the technique described herein can select an operating mode: pose control, path following, or a transitional state, as illustrative examples. Using feedback control, a control system can determine requisite forces and moment to control the motion of the vessel, such as in the surge, sway, and yaw directions. An inverse kinematic model can be used to calculate the steering angle and thrust force commands for respective propulsion devices for a set of distinct operating classes.

Limits for asymmetric thrust forces and steering angles can be considered to determine the feasibility of a respective class, to aid in selection of the operating class most suitable for a given operating regime. Forces and moment commands can be constrained, such as scaled, to the point where at least one of the available operating classes indicates a feasible result. The disclosed technique can be configured to transition between operating classes by using one or more cost functions to determine a corresponding class with specified (e.g., maximum) efficiency along with other constraints, such as consistency with a current operating condition of the vessel. The technique described herein can facilitate smooth and autonomous navigation of marine vessels across diverse scenarios, including pose control, path following, transitional states, disturbance rejection, object avoidance, or other conditions. The technique described herein can include a machine-implemented method, such as a firmware-implemented or software-implemented method executable on one or more processor circuits. Such implementation can include an embedded implementation forming a portion of a control system.

Aspects of the present subject matter can include:

### 1. State Command and Feedback Control:

The system can receive a command to move to or maintain a specific position, velocity, and orientation—collectively referred to as the “state” of the vessel. Based on the commanded state and the current state of the vessel, a technique as described herein can select an operating mode, which can be pose control, path following, or a transitional state, as illustrative examples.

### 2. Force and Moment Calculation:

Using feedback control, a system as described herein can determine appropriate forces and moments to control vessel movement in the surge (forward/backward), sway (side-to-side), and yaw (rotation) directions.

### 3. Inverse Kinematic Model:

An inverse kinematic model can be used to determine steering angle and thrust force commands for respective propulsion devices. This determination can be performed for a set of distinct operating classes, considering the constraints on asymmetric thrust forces and steering angles (associated with a respective propulsion device) to determine the feasibility of each class.

### 4. Feasibility and Scaling:

The determined forces and moments can be manipulated (e.g., scaled down) to the point where at least one of the operating classes provides a feasible result.

### 5. Transition and Efficiency Optimization:

Transitions between operating classes can be controlled by using one or more cost functions to select a corresponding class meeting a criterion such as maximizing efficiency, where the selected class also aligns with the current operating conditions of the vessel.

### 6. Diverse Scenario Adaptation:

The technique described herein can enable smooth and autonomous navigation of marine vessels across various scenarios, including pose control, path following, transitional states, disturbance rejection, and object avoidance, as illustrative examples.

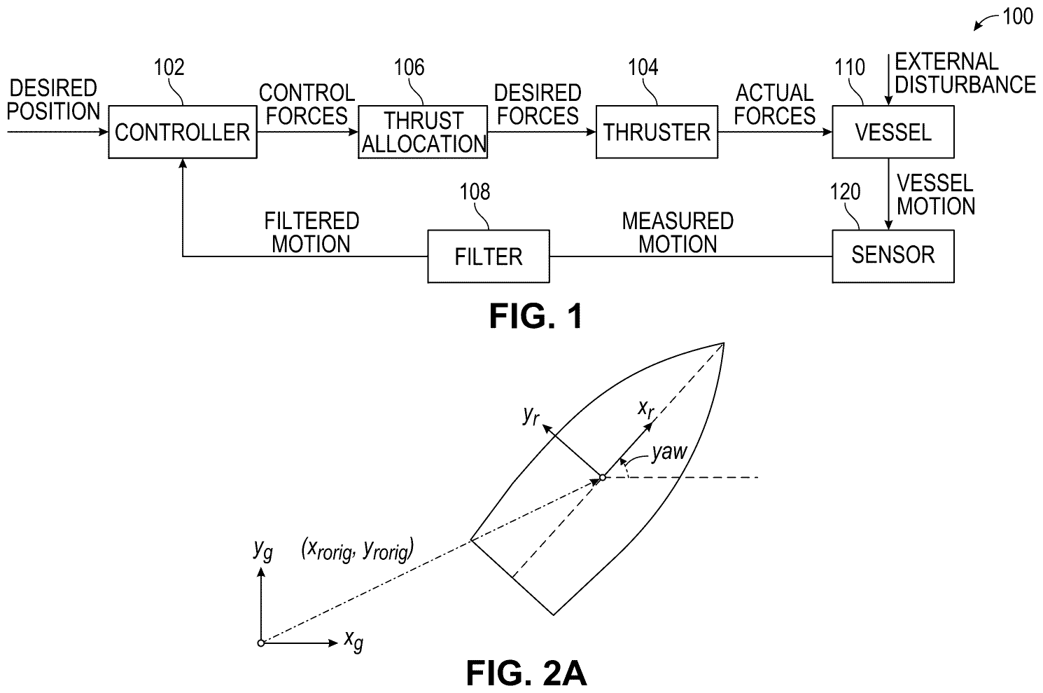

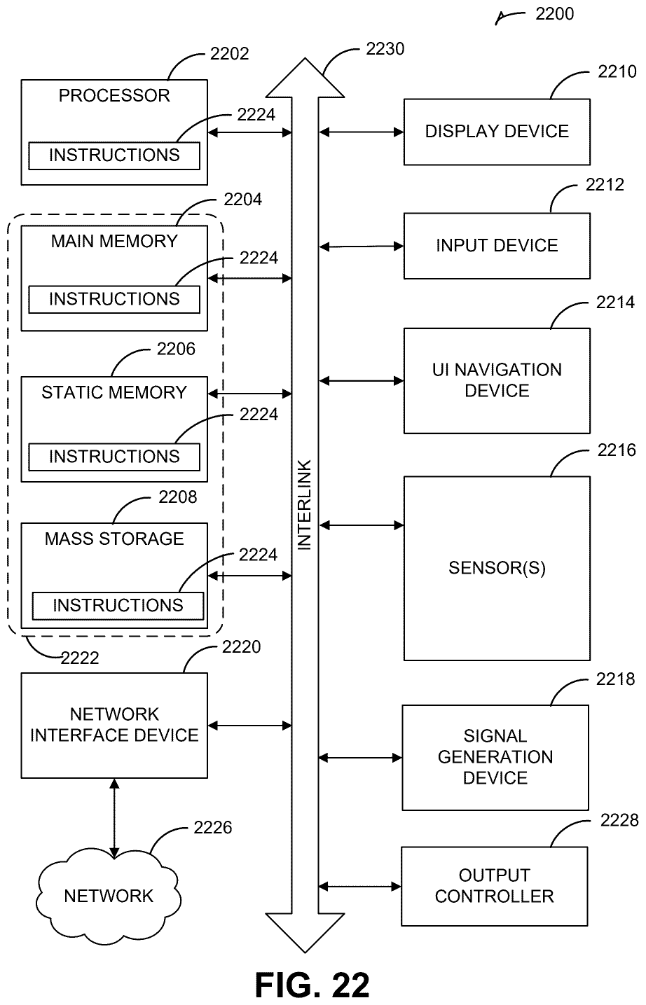

FIG. 1 illustrates generally a control system 100 scheme for control of a marine vessel. The control system 100 can include a controller 102 (e.g., comprising at least one processor circuit and at least one memory circuit, such as shown illustratively in the example of the machine 2200 of FIG. 22). Feedback-based controllers can compute target forces and moments to propel a vessel in a desired direction, such as based on the errors in position, heading, and speed. The feedback controller gains can be individually tuned for each degree of freedom and each operating mode, such as based on the vessel dynamic properties.

The architecture of FIG. 1 can be referred to as a dynamic positioning (e.g., “DP”) system architecture, in which sensor 120 measurements (e.g., from global navigation satellite systems such as Global Positioning System, gyrocompass, wind sensing, optical sensors such as LIDAR, or other sensors) can provide data indicative of position, orientation, or motion. Such data can be filtered using a filter 108 (e.g., to reject noise or disturbances such as wave action). At 106, control forces provided by the controller 102 can be allocated at 106 to individual thrusters (e.g., a thruster 104) via one or more techniques as otherwise shown and described in this document, to impart forces or moments on a vessel 110.

Generally, Unmanned Surface Vehicles (USVs) and other autonomous marine vessels can use multiple thrusters to achieve omnidirectional maneuverability. For example, a small autonomous research vessel might have thrusters distributed around its hull, enabling it to move in any direction and hold position against wind or current disturbances. Control allocation is a technique used with such USVs to perform station-keeping, trajectory tracking, and collision avoidance with precision. Similarly, advanced manned ships can incorporate autonomous functions, such as dynamically positioned offshore vessels or more exotic configurations such as double-ended ferries that can have thrusters at both bow and stern. Thrust allocation algorithms are generally used to manage their multiple thrusters safely and efficiently.

Underwater robotic vehicles are another application domain for the present techniques. For example, Remotely Operated Vehicles (ROVs) and Autonomous Underwater Vehicles (AUVs) are generally equipped with several thrusters in different orientations (e.g., arranged to control surge, sway, heave, and yaw). Robust thruster allocation allows an underwater robot to maintain stability and maneuver precisely during challenging subsea operations, even in the presence of disturbances or partial failures. Such systems are termed over-actuated because they possess more actuators than the minimum required to control the vessel's degrees of freedom.

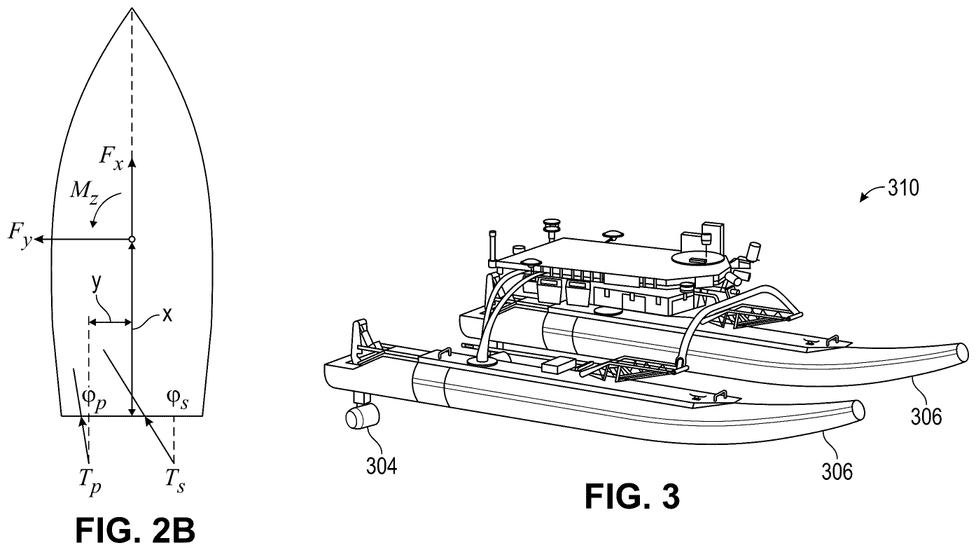

FIG. 2A illustrates generally a set of definitions for a coordinate system used in various examples described herein and FIG. 2B illustrates generally a set of further definitions including propulsion devices, forces, and moments. According to various illustrative (but non-limiting examples) herein, a vessel such as shown in FIG. 2A and FIG. 2B can be equipped with two thrusters that can provide independent forward or reverse thrust. These thrusters are arranged at a distance, X, from the Center of Rotation as shown in FIG. 2B and can be spaced apart by a distance of 2Y. The thrusters can be mounted to actuators which can rotate them independently, enabling them to apply forces in different directions for surge (forward/backward), sway (sideways), and yaw (rotational) control, such as on or nearby opposite sides of the vessel as shown in FIG. 2B. This arrangement positions the resultant forces acting on the center of gravity in the FLU coordinate frame.

Control of thruster variables such as actuation angle or thruster force can include use of a control allocation strategy that can coordinate the redundant actuators to produce desired overall motion. Control allocation can refer to a process of distributing a commanded force or moment (e.g., from a high-level controller) among the available thrusters or associated actuators. In general, vessel autopilot and dynamic positioning systems can employ a modular control architecture in which a top-level motion controller outputs a commanded control force or moment vector (e.g. desired surge force, sway force, and yaw moment), and a control allocation system can determine individual thruster commands that will generate the commanded control force vector. A modular approach can be used to decouple a higher-level controller from lower-level control logic that converts thrusts into control signals, meaning that a higher-level controller can issue commands in terms of desired vessel forces without needing to determine how each constituent thruster force

will be produced. The control allocation layer can handle details and can account for thruster or thruster actuator limitations or otherwise optimize thruster usage.
For over-actuated vessel configurations, control allocation can also be used to improve fault tolerance and flexibility by, for example, exploiting thruster or associated actuator redundancy while respecting physical limitations such as thrust limit or angular position limits.

In an over-actuated system, a complication for developing these schemes is the non-uniqueness of solutions for the actuator commands. Because in an over-actuated system there are more control inputs than controlled degrees of freedom, the mapping from desired forces/moments to individual actuator outputs is under-determined. In other words, a given commanded force vector can typically be achieved by many different combinations of thruster outputs. This non-uniqueness can be addressed by informed selection of a feasible actuation set among the many possibilities. Such an approach can also take into account limitations such as asymmetric thruster behavior where reverse and forward thrust magnitude limitations are not the same.

The control allocation techniques described in this document can incorporate limitations of the thrusters or associated actuators, such as known forward and reverse thrust limits, to provide certainty that the allocated commands stay within feasible bounds, such as for both forward and reverse directions of operation. In addition to thrust magnitude limits, there are generally directional constraints for certain types of thrusters. For example, vessels equipped with azimuthing (e.g., rotatable) thrusters or fixed thrusters mounted at an angle, the direction in which each thruster can apply force is constrained. Unlike an idealized omnidirectional force vector, a real thruster may be mechanically limited to point within a certain angular range. Generally, thrusters are assumed to have a restricted steering angle, such as 90 degrees off the forward axis in each direction. Accordingly, thruster rotation might not be able to compensate for imbalance in forward and reverse thrust capabilities. Consequently, a single thruster may not produce sway motion without generating a moment; to achieve a purely sideways force, multiple thrusters are coordinated to work together, each contributing part of the lateral force within their allowable angle. Generally, control allocation techniques take into account these angle constraints, assigning thrust components that available thrusters can physically realize.

FIG. 3 shows and illustrative example of an unmanned marine surface vessel 310 such as can be controlled using the techniques described in this document. The vessel 310 shown in FIG. 3, on which various techniques herein were evaluated, is a 16-foot (approximately 4.85 m) Wave Adaptive Modular Vessel (WAM-V) USV built on the WAM-V16 catamaran platform. This lightweight twin-hull vessel provides a stable and maneuverable base for autonomy and control research. TABLE 1, below, summarizes specifications of the WAM-V16 hull relevant to control authority and maneuverability.

TABLE 1
Specifications of an illustrative example of an unmanned vessel
with which the present control techniques can be used.

| | | |
|---|---|---|
| Length (LOA) | 16 ft | (4.85 m) |
| Beam (width) | 8 ft | (2.44 m) |
| Weight (empty) | 340 lbs | (154 kg) |
| Max Payload Capacity | ~485 lbs | (~220 kg) |

The vessel 310 configuration shown in FIG. 3 can include two thrusters (e.g., each similar to a thruster pod 304 as shown in FIG. 3 located on hull 306). The two electric thrusters of this illustrative example can include variable orientation, with each located at the stern of one of the corresponding hull. Such a configuration can be referred to as an azimuthing thruster configuration, with the example here allowing for thrust vectoring over approximately plus or minus 90 degrees from the forward direction. Specifically, in the illustrative example of the vessel 310, a pair of Copenhagen Subsea VMseries rim-driven propellers (RDPs) are used. Each RDP is mounted in a steerable pod 304 at the stern of a hull (port and starboard), and each pod is rotated by a powerful servo actuator. The servos selected are Volz DA-36LP servomotors, which deliver about 11 Newton-meters of torque for positioning the thrusters, providing sufficient authority to hold the thruster angle against hydrodynamic loads and to slew the motor pods quickly.

The mechanical steering range of each pod 304 is electronically limited to plus-or-minus 90 degrees in operation to allow a margin for calibration and avoid cable strain at extreme angles. Within this range, the thrusters can be oriented from straight ahead to perpendicular to the hull, as well as any angle in between. Combined with the RDP's capability to produce thrust in both forward and reverse directions, this essentially yields a 360-degree thrust vectoring capability on each side. With the angled thrusters, the USV can induce pure lateral forces (sway) to translate sideways. Intermediate angles allow blending of forward and lateral thrust components, enabling precise curvilinear maneuvers and in-place rotation. The vessel becomes holonomically controlled in the horizontal plane (surge, sway, and yaw), meaning it can generate force and moment in any desired planar direction.

Referring now to illustrative examples of control schemes, one aspect of the present disclosure is a technique (e.g., a machine-implemented method) for determining target control forces and moments. Upon receiving a desired state, a controller (e.g., a control system) compares the current state to the desired state and selects an operating mode: pose control, path following, or a transitional state. Depending on the selected mode, the technique can use feedback controllers to compute the appropriate forces and moments to control vessel motion consistent with establishing or maintaining the desired state. For example, if a desired state is close to a current state, the technique may select pose control, contemporaneously calculating a target surge force, a sway force, and a yaw moment using respective feedback controllers. Conversely, if the desired state is far from the current state, the technique can rotate the vessel to face the set point, ignoring the desired heading, and drive the vessel towards the set point using respective feedback controllers to manage surge and yaw motions.

When the vessel is far from the desired state, the sway error, or cross-track error, can be controlled by pointing the vessel toward the desired state without the need to independently control the sway motion. Another aspect of the control system can include use of an inverse kinematic model to calculate the thrust and steering angles suitable for respective propulsion devices to generate the desired forces and moments. The inverse kinematic model can consider multiple distinct operating classes. The controller can determine thrust forces and steering angles for each configuration and can check if the solutions are feasible (e.g., within the capabilities of specified thrust force and steering angle limits of the individual propulsion devices).

If a force/moment command vector is so large that none of the available classes produce a feasible solution, the target force/moment command vector can be adjusted (such as scaled down), such as to a scale where at least one operating class can generate a feasible solution. When multiple operating classes produce feasible solutions, a cost function can be used to select the operating class that meets one or more performance criteria, such as considering efficiency and minimizing actuator degradation. This approach can accommodate all operating modes, to provide predictive and precise control with transitions between respective modes and operating classes.

As mentioned above, marine propulsion devices often have imbalanced thrust capabilities between forward and reverse directions, influenced by thruster speeds and propeller designs. As a result, vessels may prioritize forward thrust due to its superior transient controller performance. Generally, each thruster also has a limited range of directions for generating thrust, leading to unequal capabilities in producing sway and surge forces. Controlling sway can be particularly challenging due to larger drag forces in that direction compared to surge. Such asymmetry affects maneuvering and control strategies relative to vessel performance and stability. A control scheme according to the present subject matter can help address these dynamics by selecting an effective operating mode and class to achieve a target vessel state. This can enhance performance and maneuverability while considering unique characteristics and constraints of particular marine propulsion systems.

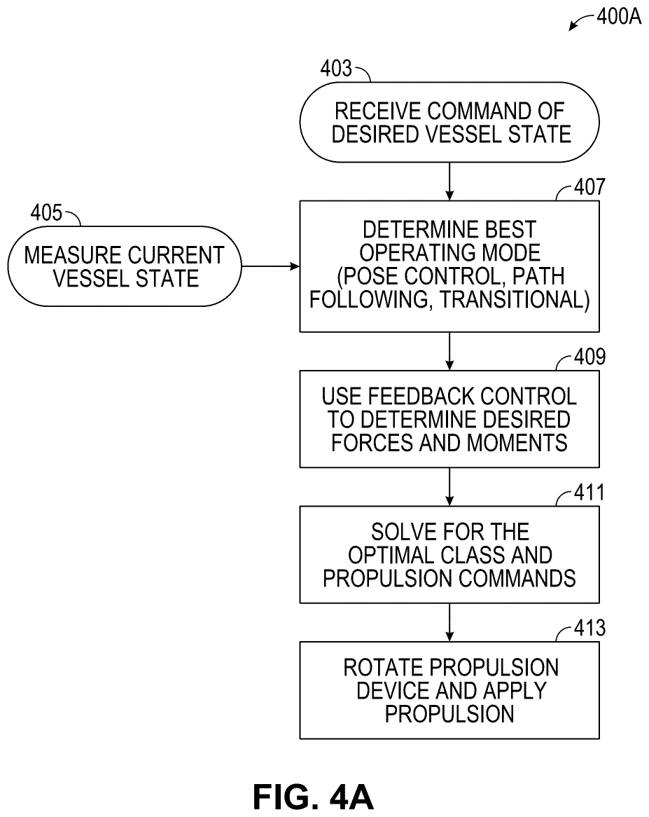

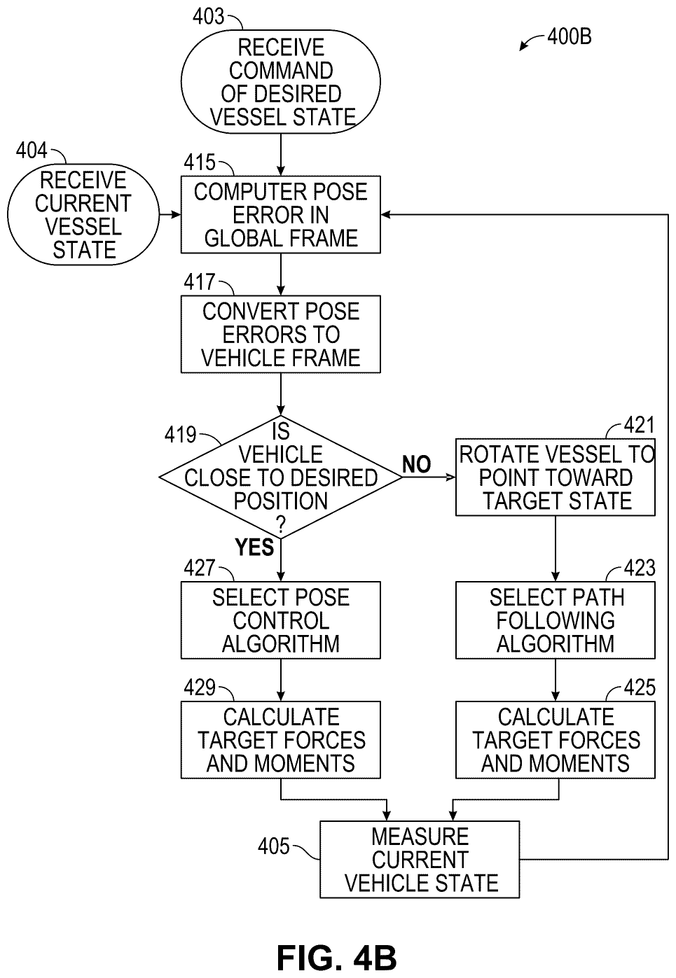

FIG. 4A shows an example comprising a high-level flowchart that can describe a technique 400A, such as a machine implemented method, for performing marine vessel control according to various examples in this document. At 403, a desired vessel state can be received (e.g., input by a user or established by another higher-level control system). At 405, a current state of the vessel can be measured using one or more sensors or using an inertial navigation system (or combinations thereof). At 407, a best operating mode can be determined. At 409, feedback control can be used to determine forces and moments to achieve the desired vessel state commanded at 403. At 411, an optimal class can be determined and associated propagation commands can be established, and at 413, one or more propulsion devices can be operated according to the desired rotational (e.g., azimuthal) and propulsion variables. Illustrative examples of different operational modes are discussed below.

### Operating Modes

In a pose control mode, the controller can drive the vessel to a selected pose (position and heading) and hold it at that pose. In a path following mode, the controller can navigate from one waypoint to the next along a desired path or trajectory. The path or trajectory can be computed from a planning algorithm, such as transitioning from an initial to a final target pose. As the vessel approaches the final target pose, the controller can use a transitional operating mode to transition from path following mode to pose control mode.

The transition state can blend the final pose speed of zero in pose control with a cruising speed from path following target, or vice versa when transitioning from pose control to speed control. The transition state can also blend the target heading from the target pose heading to the path trajectory, or vice versa, ensuring smooth and continuous adjustments during mode transitions.

The controller can provide several operating modes established to efficiently maneuver the vessel. Examples of such modes can include:

Pose Control Mode: This mode can manage motion across all three degrees of freedom contemporaneously, making it suitable for precise adjustments when the vessel is near the target state.

Path Following Mode: The vessel can follow a predefined path at a specified speed. The algorithm can prioritize surge and yaw control, with less emphasis on sway force, as an example. This mode can be selected when the target surge velocity is nonzero or when the vessel is far from the target state. Initially, a target heading can point directly towards a desired set point. As the vessel nears the set point, the target heading can smoothly transition to align with a path trajectory. The modes mentioned above can enhance or optimize maneuverability such as by adapting control strategies based on the vessel proximity to a target state and the dynamics of the desired path.

FIG. 4B shows an illustrative example comprising a flowchart that can describe a technique 400B, such as a machine implemented method, for performing mode selection for marine vessel control according to various examples in this document. Similar to FIG. 4A, at 403 a desired vessel state can be received. At 404 a current vessel state can be received (e.g., measured at 405 or provided by another system). A pose error can be determined at 415, such as determined with respect to a global coordinate frame. At 417, the pose error can be converted to a coordinate frame of the vehicle (e.g., see FIG. 2A for the difference between global and vessel frames). At 419, an evaluation can be made as to whether the vehicle is close to a desired position (e.g., within a specified angular deviation from the desired pose with respect to one or more pose parameters). If the evaluation indicates that the vehicle is not close to the desired position, at 421 the vessel can be rotated to point toward the desired target state, at 423 a path following algorithm can be selected, and at 425 target forces and moments can be established, such as used to control one or more thrusters. If at 419 the evaluation indicates that the vehicle is close to the desired position, a pose control algorithm can be selected at 427, and corresponding target forces and moments of the pose control mode can be established at 429. At 405 the current vehicle state can be measured again (providing a feedback topology).

A force/moment command vector can be translated into individual steering angles and thrust forces for respective propulsion devices, such as in response to the operating mode being selected and the target force/moment command vector being determined. The present inventors have recognized, among other things, that there is no existing process for converting between force/moment commands and individual component commands.

To address this challenge, a new process can be used. This process can include multiple defined operating classes, solution of an inverse kinematic model for each class, and an approach to identify the most suitable solution (e.g., optimization). This approach can provide effective translation of force/moment commands into actionable commands for respective propulsion devices to effectuate a navigation or control strategy (or both).

### Forward Kinematic Model

After the controller has determined, for example, the desired forces and yaw moment to apply to the vessel, these forces and moment are translated into thrust forces and steering angles for respective propulsion devices (e.g., some or all available propulsion devices). A forward kinematic model can be found that uses the steering angles and thrusts of each propulsion device to calculate the forces/moment applied to the vessel. FIG. 2B shows a free-body-diagram (FBD) of the vessel, ignoring drag and disturbance forces/moments, indicating the respective parameters. The location of the coordinate system can be set at any location. In this example, the coordinate system is assumed to be in the center of the vessel at a distance, X, forward of the propulsion devices. The propulsion devices are assumed to be symmetrical about the centerline with an average distance for the devices to be Y in the port/starboard direction, as shown in FIG. 2B.

Based on the FBD of FIG. 2B, the forward kinematic equations can be represented as:

$$[ \begin{matrix}{F}_{x} \\ {F}_{y} \\ {M}_{z}\end{matrix} ] = [ \begin{matrix}{T}_{p} cos ( {ϕ}_{p} ) + {T}_{s} cos ( {ϕ}_{s} ) \\ {T}_{p} sin ( {ϕ}_{p} ) + {T}_{s} sin ( {ϕ}_{s} ) \\ {T}_{p} sin ( {ϕ}_{p} ) X - {T}_{s} sin ( {ϕ}_{s} ) X - {T}_{p} cos ( {ϕ}_{p} ) Y + {T}_{s} cos ( {ϕ}_{s} ) Y\end{matrix} ]$$

The sway drag force can introduce a yaw moment on the vessel based on a few factors, including vessel speed, and hull shape. To simplify the calculations, the potential yaw moment produced by sway drag forces can be accounted for in one of two ways. The location of the coordinate system can be placed coaxial with the sway drag force. In practice, the location of this point can be found experimentally or through simulation. This approach will result in the yaw moment from sway drag forces being equal to zero. In another approach, the yaw moment caused by the sway drag force can be counteracted as part of the target yaw moment calculations. Using either approach, the yaw moment caused by the sway drag force can be represented as zero in the kinematic model. Although the disclosed method is not dependent on this simplification, it facilitates a more straight-forward description of the process.

Before introducing the inverse kinematic models, the forward kinematic model can be simplified. It can be observed that a component of the yaw moment is a function of the sway force.

$$[ \begin{matrix}{F}_{x} \\ {F}_{y} \\ {M}_{z}\end{matrix} ] = [ \begin{matrix}{T}_{p} cos ( {ϕ}_{p} ) + {T}_{s} cos ( {ϕ}_{s} ) \\ {T}_{p} sin ( {ϕ}_{p} ) + {T}_{s} sin ( {ϕ}_{s} ) \\ - {F}_{y} X - {T}_{p} cos ( {ϕ}_{p} ) Y + {T}_{s} cos ( {ϕ}_{s} ) Y\end{matrix} ]$$

The sway force (Fy) and location of the coordinate system (X,Y) can be considered known inputs for the inverse kinematic model, and these terms can be grouped together on the same side of the equation as the target forces/moment terms, as shown below.

$$[ \begin{matrix}{F}_{x} \\ {F}_{y} \\ \frac{( {M}_{z} + {F}_{y} X )}{Y}\end{matrix} ] = [ \begin{matrix}{T}_{p} cos ( {ϕ}_{p} ) + {T}_{s} cos ( {ϕ}_{s} ) \\ {T}_{p} sin ( {ϕ}_{p} ) + {T}_{s} sin ( {ϕ}_{s} ) \\ - {T}_{p} cos ( {ϕ}_{p} ) + {T}_{s} cos ( {ϕ}_{s} )\end{matrix} ]$$

The inverse kinematic model cannot be solved for directly with the current set of equations because there are only three equations and four variables: Port Steering Angle φₚ, Starboard Steering Angle φₛ, Port Thrust Tₚ, and Starboard Thrust Tₛ. An additional kinematic equation can be used. The additional kinematic equation used can be based on the operating class, as described below.

### Force/Moment Workspace and Classification

The force/moment workspace of a propulsion system can be defined as a range of forces and moments that can be applied to a vessel within the operational limits of its propulsion devices. While obtaining a closed-form inverse kinematic solution for a specific force/moment command is generally not possible, it is possible to use the forward kinematic model to explore an overall workspace. This analysis can be used to determine the size and shape of the total force/moment workspace.

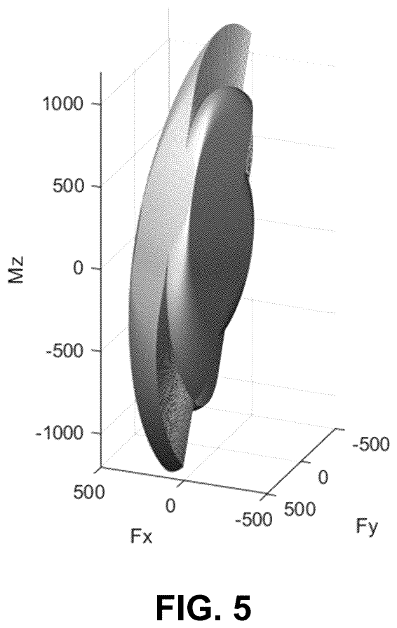

FIG. 5 shows an illustrative example comprising a “workspace” defined as a locus of force and moment combinations addressable by a marine vessel control technique. For example, performing a forward kinematic analysis on a reference marine vessel with Y=1 meter (m), X=2.24 m, forward thrust limits of 250 Newton (N), reverse thrust limits of −100N, and steering angle limits of +/−90 degrees reveals the force/moment workspace depicted in FIG. 5. This workspace illustrates the extent and shape of achievable forces and moments within these operational constraints (which are merely an illustrative but non-limiting example). In FIG. 5, a solid area shows where a combination of forces and moments can be realized within the volume, demonstrating vessel maneuvering capabilities within its specified limits.

An inverse kinematic analysis can be used to derive a set of equations that allow the control system to use a force/moment command vector to find the thrust and steering angle commands for respective propulsion devices. While a closed-form inverse kinematic solution is not identifiable covering the entire workspace, due to the imbalance of variables and equations, a closed-form solution can be found if an additional constraint is applied. For example, a machine learning classifier can be employed to identify a candidate set of constraints needed to replicate the force/moment vectors on a surface of the total workspace. Classifiers in machine learning can be used to assign labels to data points based on their features, revealing patterns and relationships between these features and labels.

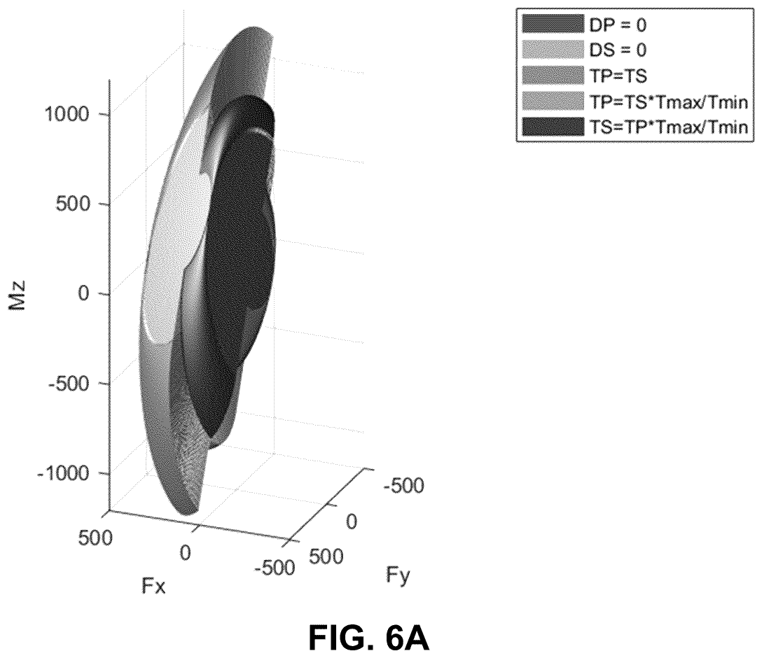

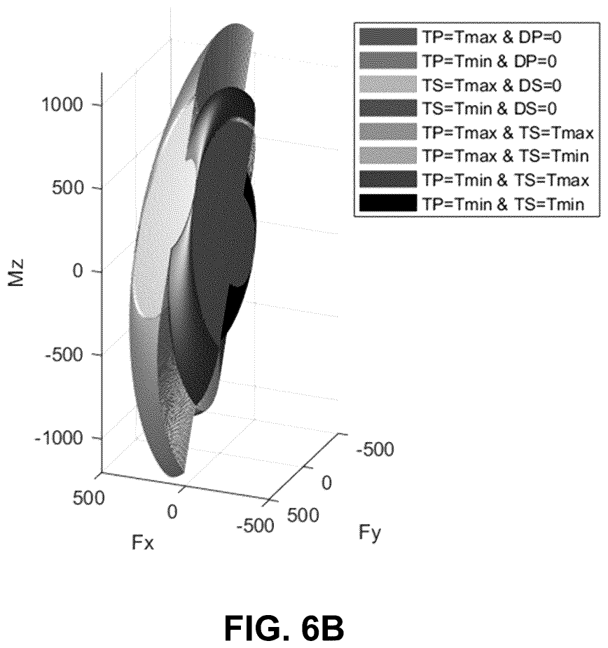

FIG. 6A shows an illustrative example comprising a “workspace” separated by class definition and limiting thrust and FIG. 6B shows another illustrative example comprising a “workspace” separated by class definition and limiting thrust. It was determined that the entire volume depicted by the workspace of FIG. 5 can be represented by a solution defined by, as an illustrative example, one of five constraints. These five constraints can be used to define five distinct operating classes. Each class has its own subspace, and collectively these five subspaces can be used to reproduce an entire volume of the total workspace. The identified constraints are given below, for the example of two thrusters, and the subspaces are depicted in FIG. 6A:

$$Port Steering Angle = 0 ; \qquad ( 1 )$$

$$Starboard Steering Angle = 0 ; \qquad ( 2 )$$

$$Port Thrust = Starboard Thrust ; \qquad ( 3 )$$

$$Port Thrust = Starboard Thrust * {T}_{max} / {T}_{min} ; and \qquad ( 4 )$$

$$Starboard Thrust = Port Thrust * {T}_{max} / {T}_{min} . \qquad ( 5 )$$

On the surface of the total workspace, at least one propulsion device operates at its maximum thrust limit, Tₘₐₓ, or minimum thrust limit, Tₘᵢₙ. Solutions inside the surface and along the same unit vector can be achieved by scaling the propulsion thrusts by a factor less than 1. FIG. 6B shows the workspace regions based on class and active thrust limit.

Along a surface of the total workspace, typically only one class is active. However, at the boundaries between different classes, multiple classes may be valid. For example, a force/moment command vector might fall within both class 1 (Port Steering (DP)=0) and class 3 (Port Thrust (TP)=Steering Thrust (TS)). In such cases, a solution will satisfy the requirements of both classes, such as having both thrusts equal to the maximum thrust limit and the port steering angle set to zero. This boundary delineates where class 1 transitions into class 3. Recognizing these boundaries satisfy multiple constraints enables an analytical definition of the boundary to be defined as a function of the input forces and moment.

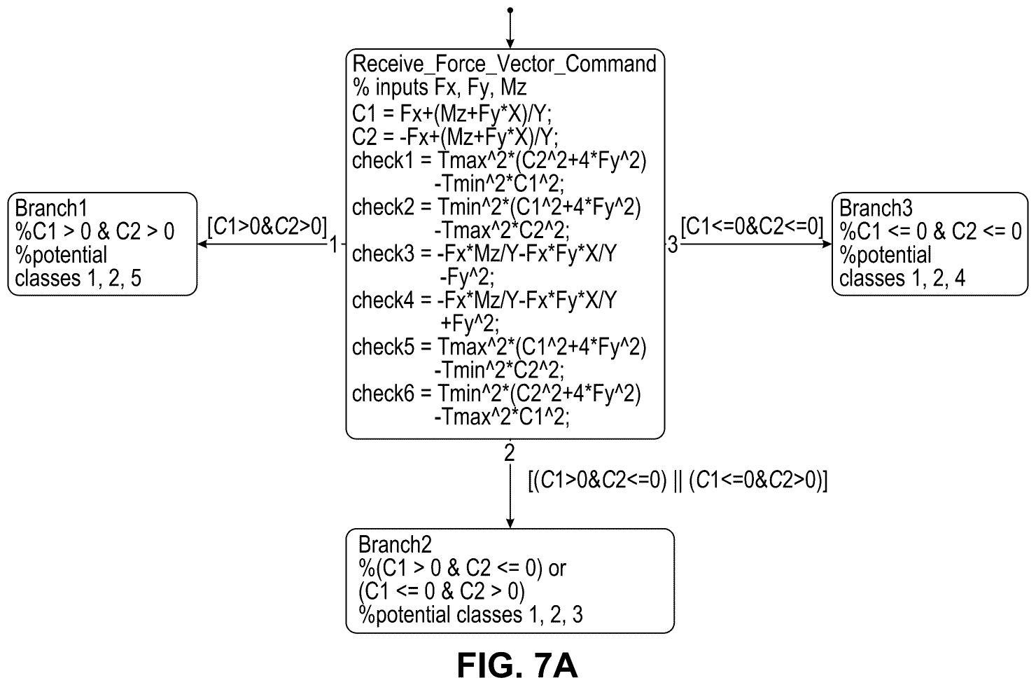

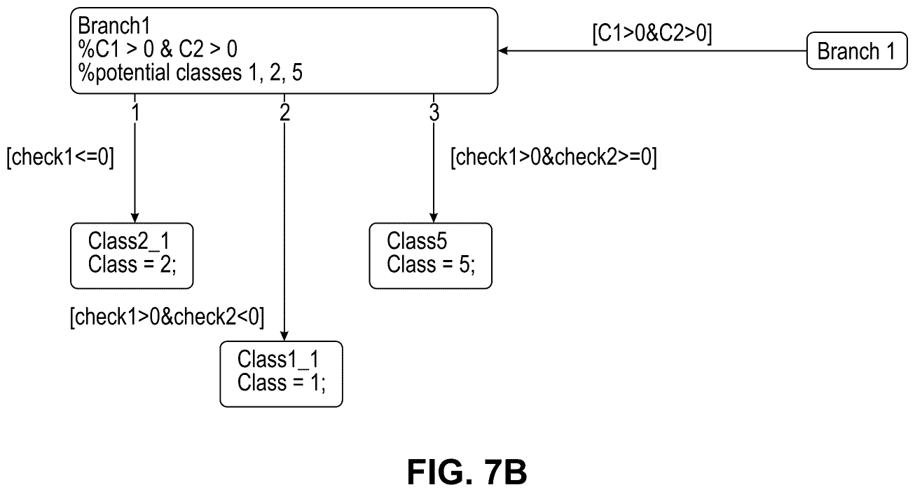

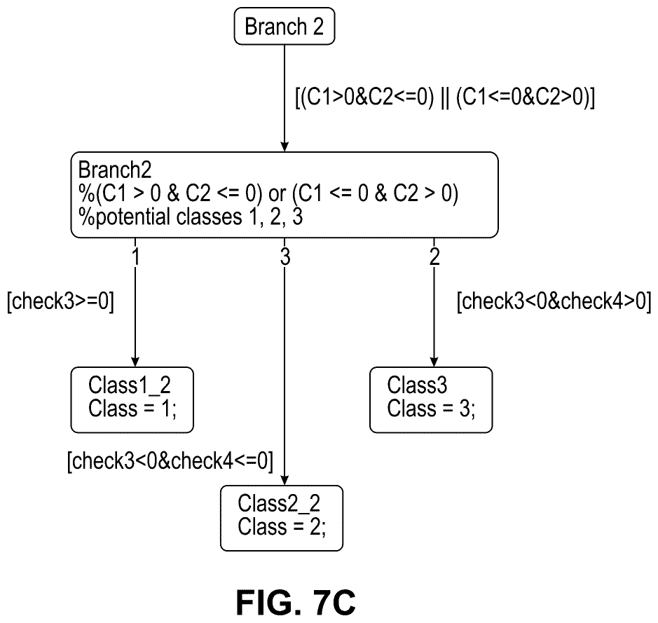

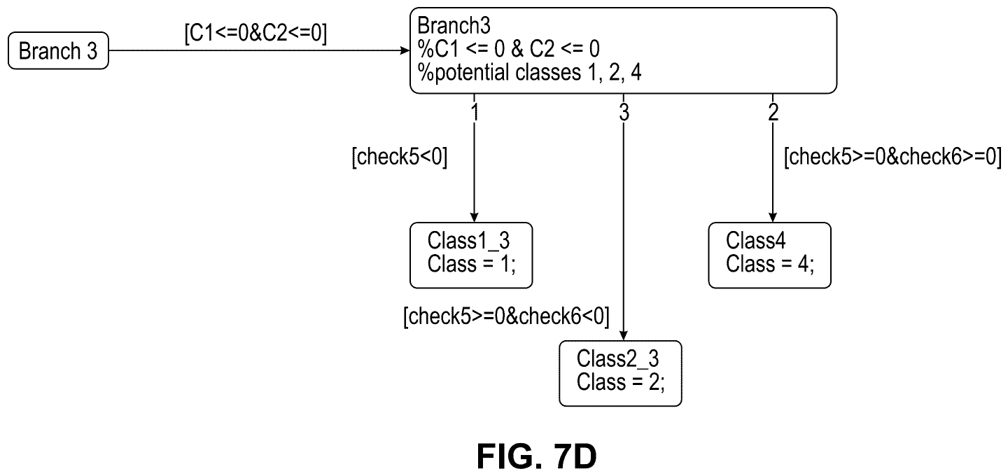

FIG. 7A shows an illustrative example comprising a flowchart for establishing an operating class with a specified force/moment vector, including three branches. When the control system receives a force/moment command, a technique as described herein can programmatically determine an operating class capable of producing the maximum achievable force/moment vector, such as corresponding to the flowchart in FIG. 7A. As an illustrative example, the flowchart employs eight terms derived from the input force/moment vector to select a branch, identifying which class can generate the largest achievable force/moment vector along the defined unit vector. The eight terms that define the boundaries between the classes are shown below.

TABLE 2
Flowchart terms

| | |
|---|---|
| c₁= Fₓ + (M_{z} + F_{y}X)/Y | c2 = −Fₓ + (M_{z} + F_{y}X)/Y |
| ${check}_{1} = {T}_{max}^{2} ( {c}_{2}^{2} + 4 {F}_{y}^{2} ) - {T}_{min}^{2} {c}_{1}^{2}$ | ${check}_{2} = {T}_{min}^{2} ( {c}_{1}^{2} + 4 {F}_{y}^{2} ) - {T}_{max}^{2} {c}_{2}^{2}$ |
| ${check}_{3} = - \frac{{F}_{x} {M}_{z}}{Y} - \frac{{F}_{x} {F}_{y} X}{Y} - {F}_{y}^{2}$ | ${check}_{4} = - \frac{{F}_{x} {M}_{z}}{Y} - \frac{{F}_{x} {F}_{y} X}{Y} + {F}_{y}^{2}$ |
| ${check}_{5} = {T}_{max}^{2} ( {c}_{1}^{2} + 4 {F}_{y}^{2} ) - {T}_{min}^{2} {c}_{2}^{2}$ | ${check}_{6} = {T}_{min}^{2} ( {c}_{2}^{2} + 4 {F}_{y}^{2} ) - {T}_{max}^{2} {c}_{1}^{2}$ |

FIG. 7B shows an illustrative example comprising a flowchart corresponding to Branch 1 of the flowchart of FIG. 7A, FIG. 7C shows an illustrative example comprising a flowchart corresponding to Branch 2 of the flowchart of FIG. 7A, and FIG. 7D shows an illustrative example comprising a flowchart corresponding to Branch 3 of the flowchart of FIG. 7A. In addition to identifying the class that can produce the maximum force/moment vector for a given input command, a determination can be made as to whether the input is “achievable.” A force/moment command generated by the feedback controller may lie inside the total workspace and therefore be “achievable,” or outside the volume of the total workspace and hence “unachievable.” As shown above in FIG. 6B, at least one thrust limit will be active on the outer surface of the workspace volume regardless of class.

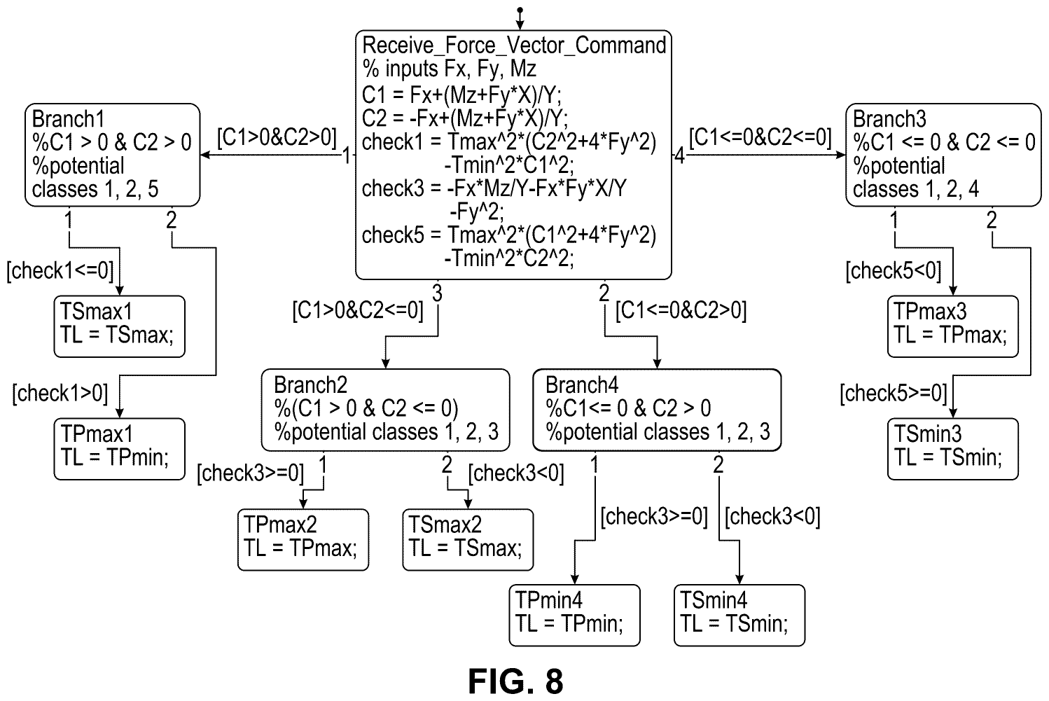

FIG. 8 shows an illustrative example comprising a flowchart for establishing a thrust limit on a surface of a workspace, such as the workspace shown illustratively in FIG. 6B. Once the class is identified, a thrust limit can be identified which defines the maximum achievable force/moment values. For the illustrative examples herein, a classifier was employed to determine which thrust limit is active for every point on the surface of the total workspace. This classifier is represented as a flowchart in FIG. 8. The flowchart calculates five terms (c1, c2, check1, check3 and check 5), a subset of the eight terms used in the previous flowchart of FIG. 7A, to ascertain the thrust limit that is active at the surface of the total workspace in the direction of the unit vector defined by the force/moment command vector.

Once the active thrust limit is identified, a maximum achievable force/moment command can be determined along the unit vector defined by the input force/moment command. Below is an illustrative example of a process flow for such a determination:

1. Comparison with Maximum Achievable Command: If the force/moment command generated by the feedback controller is less than the maximum achievable command (determined based on the active thrust limit), then the target command can be used for all subsequent calculations.

2. Scaling Down for Larger Commands: If the force/moment command from the feedback controller exceeds the maximum achievable command, the command vector is scaled down to match the maximum achievable command. This scaled-down command vector can then be employed for all future calculations.

This approach ensures that the vessel operates within physical limits, optimizing performance while maintaining safe and efficient maneuvering based on the capabilities of the vessel propulsion system.

### Class Descriptions and Closed Form Solutions

There are many potential operating classes that could be used by the controller. Ten such classes are defined below, as illustrative examples, with five primary classes capable of recreating the total workspace. In this illustration, there are three additional classes presented for selection, which may improve efficiency in some maneuvers, and two classes for fault mitigation.

1. Primary Classes (5 classes):

These classes cover a broad range of maneuvers and operational scenarios, ensuring comprehensive coverage of the vessel's workspace.

2. Efficiency Classes (3 classes):

These classes are specialized to provide more efficient operations for specific maneuvers or conditions, optimizing energy use or performance metrics.

3. Fault Mitigation Classes (2 classes):

These classes are designed to handle faults or unexpected situations, ensuring safety and reliability in adverse conditions.

Each class offers different attributes. This structured approach provides suitable vessel control across various tasks and challenges.

### Class 1: Port Steering Angle Equal to Zero

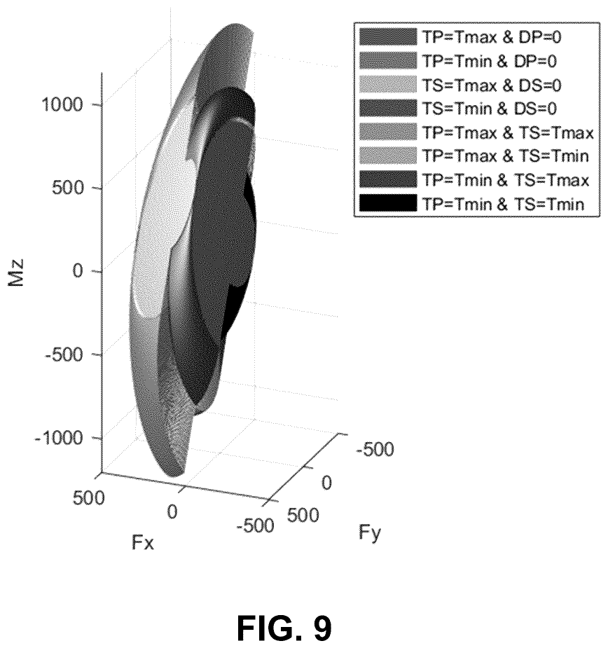

FIG. 9 shows an illustrative example comprising a subspace of the “workspace” of FIG. 6B, corresponding to “Class 1.” The first classification is defined by the port steering angle being equal to zero. This class has a subspace volume that occupies 19.35% of the total workspace for the prior example. As determined by the classifier, this class reaches the surface of the total workspace for two potential thrust limits: port thrust equal to the maximum propulsion device positive thrust (Tmax) and port thrust equal to the maximum propulsion device negative thrust (Tmin). Although the volume of the subspace for this class may include propulsion commands where the starboard thrust is at a thrust limit, none of these solutions correspond to a region where this class produces the maximum achievable force/moment command vector.

For this class, the forward kinematic equations can be simplified. Note that the input forces Fₓ, F_{y}, M_{z} and the vessel configuration X, and Y are considered known values for this derivation.

$$[ \begin{matrix}{F}_{x} \\ {F}_{y} \\ \frac{( {M}_{z} + {F}_{y} X )}{Y}\end{matrix} ] = [ \begin{matrix}{T}_{p} + {T}_{s} cos ( {ϕ}_{s} ) \\ {T}_{s} sin ( {ϕ}_{s} ) \\ - {T}_{p} + {T}_{s} cos ( {ϕ}_{s} )\end{matrix} ]$$

Solving these three equations for the three remaining propulsion commands, when φₚ=0.

$$\begin{matrix}{T}_{p} = \frac{( {F}_{x} - \frac{( {M}_{z} + {F}_{y} X )}{Y} )}{2} \\ \vert {T}_{s} \vert = \sqrt{{( {F}_{y} )}^{2} + {( \frac{( {F}_{x} + \frac{( {M}_{z} + {F}_{y} X )}{Y} )}{2} )}^{2}} \\ {ϕ}_{s} = {tan}^{- 1} ( \frac{2 {F}_{y}}{( {F}_{x} + \frac{( {M}_{z} + {F}_{y} X )}{Y} )} )\end{matrix}$$

The sign of Tₛ is determined by considering both the positive and negative values but only keeping the one that produces the desired force/moment command vector. In practice, the atan2 function (e.g., 2-argument arctangent) is used instead of the atan function to ensure the angle is returned in the correct quadrant.

### Class 2: Starboard Steering Angle Equal to Zero

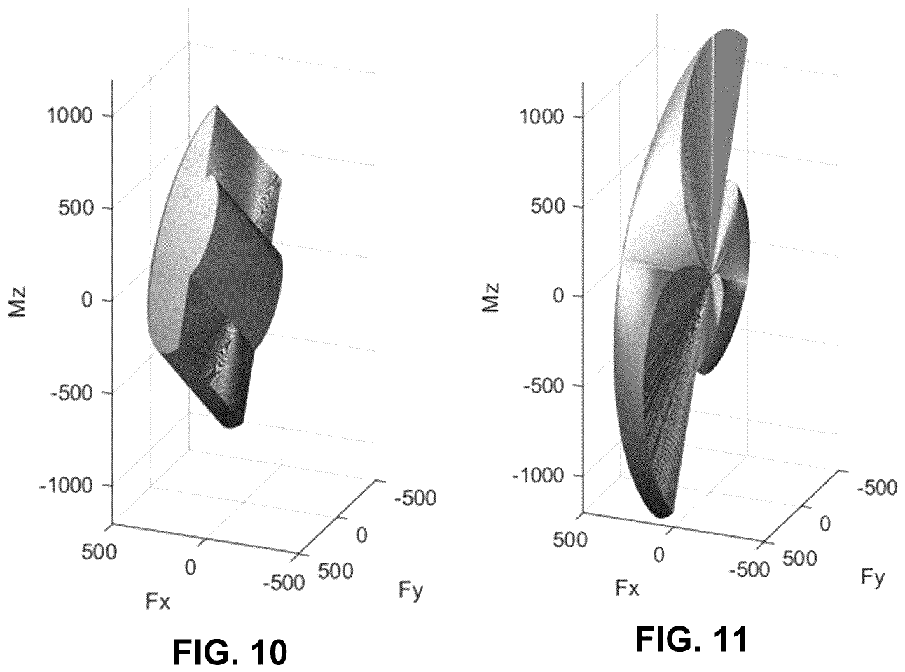

FIG. 10 shows an illustrative example comprising a subspace of the “workspace” of FIG. 6B, corresponding to “Class 2.” The second classification is defined by the starboard steering angle being equal to zero. This class has a subspace volume that occupies 19.35% of the total workspace for the prior example. As determined by the classifier, this class reaches the surface of the total workspace for two potential thrust limits: starboard thrust equal to the maximum propulsion device positive thrust (Tmax) or starboard thrust equal to the maximum propulsion device negative thrust (Tmin). Although the volume of the subspace for this class may include propulsion commands where the port thrust is at a thrust limit, none of these solutions correspond to a region where this class produces the maximum achievable force/moment command vector.

For this class, the forward kinematic equations can be simplified. Note that the input forces Fₓ, F_{y}, M_{z} and the vessel configuration X, and Y are considered known values for this derivation.

$$[ \begin{matrix}{F}_{x} \\ {F}_{y} \\ \frac{( {M}_{z} + {F}_{y} X )}{Y}\end{matrix} ] = [ \begin{matrix}{T}_{p} cos ( {ϕ}_{p} ) + {T}_{s} \\ {T}_{p} sin ( {ϕ}_{p} ) \\ - {T}_{p} cos ( {ϕ}_{p} ) + {T}_{s}\end{matrix} ]$$

Solving these three equations for the three remaining propulsion commands, when φₛ=0.

$$\begin{matrix}{T}_{s} = \frac{( {F}_{x} + \frac{( {M}_{z} + {F}_{y} X )}{Y} )}{2} \\ \vert {T}_{p} \vert = \sqrt{{( {F}_{y} )}^{2} + {( \frac{( {F}_{x} - \frac{( {M}_{z} + {F}_{y} X )}{Y} )}{2} )}^{2}} \\ {ϕ}_{p} = {tan}^{- 1} ( \frac{2 {F}_{y}}{( {F}_{x} - \frac{( {M}_{z} + {F}_{y} X )}{Y} )} )\end{matrix}$$

The sign of Tₚ is determined by considering both the positive and negative values but only keeping the one that produces the desired force/moment command vector. In practice, the atan2 function is again used instead of the atan function to ensure the angle is returned in the correct quadrant.

### Class 3: Port Thrust Equal to Starboard Thrust

FIG. 11 shows an illustrative example comprising a subspace of the “workspace” of FIG. 6B, corresponding to “Class 3.” The third classification is defined by the starboard thrust being equal to the port thrust. This class has a subspace volume that occupies 57.1% of the total workspace for the prior example. As determined by the classifier algorithm, this class reaches the surface of the total workspace for two potential thrust limits: when both thrusts are equal to the maximum propulsion device positive thrust (Tmax) or both thrusts are equal to the maximum propulsion device negative thrust (Tmin).

For this class, the forward kinematic equations can be simplified. Note that the input forces Fₓ, F_{y}, M_{z} and the vessel configuration X, and Y are considered known values for this derivation. The port and starboard thrust values are equal and defined as Tₚₛ.

$$[ \begin{matrix}{F}_{x} \\ {F}_{y} \\ \frac{( {M}_{z} + {F}_{y} X )}{Y}\end{matrix} ] = [ \begin{matrix}{T}_{p s} cos ( {ϕ}_{p} ) + {T}_{p s} cos ( {ϕ}_{s} ) \\ {T}_{p s} sin ( {ϕ}_{p} ) + {T}_{p s} sin ( {ϕ}_{s} ) \\ - {T}_{p s} cos ( {ϕ}_{p} ) + {T}_{p s} cos ( {ϕ}_{s} )\end{matrix} ]$$

Using the first and third equations, the following equations for the two angles are found as a function of the common thrust Tₚₛ.

$$\begin{matrix}{ϕ}_{p} = {cos}^{- 1} ( \frac{( {F}_{x} - \frac{( {M}_{z} + {F}_{y} X )}{Y} )}{2 {T}_{p s}} ) \\ {ϕ}_{s} = {cos}^{- 1} ( \frac{( {F}_{x} + ( {M}_{z} + {F}_{y} X ) / Y )}{2 {T}_{p s}} )\end{matrix}$$

Substituting the two angles in the Fy equation results in one equation with one unknown for the common thrust.

$${F}_{y} = {T}_{p s} \sqrt{1 - {( \frac{( {F}_{x} - \frac{( {M}_{z} + {F}_{y} X )}{Y} )}{2 {T}_{p s}} )}^{2}} + {T}_{p s} \sqrt{1 - {( \frac{( {F}_{x} + \frac{( {M}_{z} + {F}_{y} X )}{Y} )}{2 {T}_{p s}} )}^{2}}$$

To condense the solution, the following constants can be defined.

$${c}_{1} = \frac{( {F}_{x} - \frac{( {M}_{z} + {F}_{y} X )}{Y} )}{2}$$

$${c}_{2} = \frac{( {F}_{x} + \frac{( {M}_{z} + {F}_{y} X )}{Y} )}{2}$$

Squaring the equation once and rearranging results in the following equation.

$${F}_{y}^{2} - ( {T}_{p s}^{2} - {c}_{1}^{2} ) - ( {T}_{p s}^{2} - {c}_{2}^{2} ) = 2 \sqrt{( {T}_{p s}^{2} - {c}_{1}^{2} ) ( {T}_{p s}^{2} - {c}_{2}^{2} )}$$

Squaring this equation results in the following expression. The highlighted terms cancel out resulting in a simpler equation.

$${F}_{y}^{4} - 4 {F}_{y}^{2} {T}_{p s}^{2} + 2 {F}_{y}^{2} {c}_{1}^{2} + 2 {F}_{y}^{2} {c}_{2}^{2} + 4 {T}_{p s}^{4} - 4 {T}_{p s}^{2} {c}_{1}^{2} - 4 {T}_{p s}^{2} {c}_{2}^{2} + {c}_{1}^{4} + 2 {c}_{1}^{2} {c}_{2}^{2} + {c}_{2}^{4} = 4 {T}_{p s}^{4} - 4 {T}_{p s}^{2} {c}_{1}^{2} - 4 {T}_{p s}^{2} {c}_{2}^{2} + 4 {c}_{1}^{2} {c}_{2}^{2}$$

The simplified express is shown below.

$${F}_{y}^{4} + 2 {F}_{y}^{2} {c}_{1}^{2} + 2 {F}_{y}^{2} {c}_{2}^{2} + {c}_{1}^{4} - 2 {c}_{1}^{2} {c}_{2}^{2} + {c}_{2}^{4} = 4 {F}_{y}^{2} {T}_{p s}^{2}$$

Since there is only one term with Tₚₛ, the thrust value can be solved as shown below. The thrust can be positive or negative depending on the force/moment vector command.

$${T}_{p s} = \pm \sqrt{\frac{{( {c}_{1}^{2} + {c}_{2}^{2} - {F}_{y}^{2} )}^{2} - 4 {c}_{1}^{2} {c}_{2}^{2}}{4 {F}_{y}^{2}}}$$

Knowing the thrust value, the magnitude of the two angles can be found using the previously defined equations. The signs of the angles and thrust can be determined by checking each combination of positive and negative values and selecting the combination that matches the force/moment vector command.

An illustrative example of this process is shown below, where four potential values for the sway force are calculated based on the magnitude of the angles. The sign of the thrust force will be the same as the sign of the active thrust limit, such as found using a technique corresponding to the flowchart in FIG. 8. However, because cosine is an even function, the inverse cosine returns an absolute value of the angle.

$${F}_{y , 1} = {T}_{p s} sin ( {ϕ}_{p} ) + {T}_{p s} sin ( {ϕ}_{s} )$$

$${F}_{y , 2} = {T}_{p s} sin ( - {ϕ}_{p} ) + {T}_{p s} sin ( {ϕ}_{s} )$$

$${F}_{y , 3} = {T}_{p s} sin ( {ϕ}_{p} ) + {T}_{p s} sin ( - {ϕ}_{s} )$$

$${F}_{y , 4} = {T}_{p s} sin ( - {ϕ}_{p} ) + {T}_{p s} sin ( - {ϕ}_{s} )$$

All four potential solutions can be compared to the requested sway force F_{y}. The set of angles that reproduce the desired sway force van be used in the propulsion command vector.

Class 4: Starboard Thrust equal to Port Thrust times the ratio of the max thrust limit to the minimum thrust limit

FIG. 12 shows an illustrative example comprising a subspace of the “workspace” of FIG. 6B, corresponding to “Class 4.” The fourth classification is defined by the starboard thrust being equal to the port thrust times the ration of the maximum forward thrust (Tmax) to the maximum reverse thrust (Tmin). This class has a subspace volume that occupies 15.0% of the total workspace for the prior example. As determined by the classifier, this class reaches the surface of the total workspace for one thrust limit: when the port thrust is equal to the maximum propulsion device positive thrust (Tmax) and the starboard thrust is equal to the maximum propulsion device negative thrust (Tmin). For this class, the forward kinematic equations can be simplified. Note that the input forces Fₓ, F_{y}, M_{z} and the vessel configuration X, and Y are considered known values for this derivation. The ratio of the maximum forward thrust to the maximum rearward thrust can be defined as α.

$$[ \begin{matrix}{F}_{x} \\ {F}_{y} \\ \frac{( {M}_{z} + {F}_{y} X )}{Y}\end{matrix} ] = [ \begin{matrix}{T}_{p} cos ( {ϕ}_{p} ) + α {T}_{p} cos ( {ϕ}_{s} ) \\ {T}_{p} sin ( {ϕ}_{p} ) + α {T}_{p} sin ( {ϕ}_{s} ) \\ - {T}_{p} cos ( {ϕ}_{p} ) + α {T}_{p} cos ( {ϕ}_{s} )\end{matrix} ]$$

Using the first and third equations, the following equations for the two angles are found as a function of the port thrust Tₚ.

$${ϕ}_{p} = {cos}^{- 1} ( \frac{( {F}_{x} - \frac{( {M}_{z} + {F}_{y} X )}{Y} )}{2 {T}_{p}} )$$

$${ϕ}_{s} = {cos}^{- 1} ( \frac{( {F}_{x} + \frac{( {M}_{z} + {F}_{y} X )}{Y} )}{2 α {T}_{p}} )$$

Substituting the two angles in the Fy equation results in one equation with one unknown for the port thrust.

$${F}_{y} = {T}_{p} \sqrt{1 - {( \frac{( {F}_{x} - \frac{( {M}_{z} + {F}_{y} X )}{Y} )}{2 {T}_{p}} )}^{2}} + α {T}_{p} \sqrt{1 - {( \frac{( {F}_{x} + \frac{( {M}_{z} + {F}_{y} X )}{Y} )}{2 α {T}_{p}} )}^{2}}$$

To condense the solution, the following constants can be defined.

$${c}_{1} = \frac{( {F}_{x} - \frac{( {M}_{z} + {F}_{y} X )}{Y} )}{2}$$

$${c}_{2} = \frac{( {F}_{x} + \frac{( {M}_{z} + {F}_{y} X )}{Y} )}{2}$$

Squaring the equation once and rearranging results in the following equation.

$${F}_{y}^{2} - ( {T}_{p}^{2} - {c}_{1}^{2} ) - ( {α}^{2} {T}_{p}^{2} - {c}_{2}^{2} ) = 2 \sqrt{( {T}_{p}^{2} - {c}_{1}^{2} ) ( {α}^{2} {T}_{p}^{2} - {c}_{2}^{2} )}$$

Squaring this equation results in the following expression.

$$( {α}^{4} + 2 {α}^{2} + 1 ) {T}_{p}^{4} + ( - 2 {α}^{2} {F}_{y}^{2} - 2 {F}_{y}^{2} - 2 {α}^{2} {c}_{1}^{2} - 2 {α}^{2} {c}_{2}^{2} - 2 {c}_{1}^{2} - 2 {c}_{2}^{2} ) {T}_{p}^{2} + ( {F}_{y}^{4} + 2 {F}_{y}^{2} {c}_{1}^{2} + 2 {F}_{y}^{2} {c}_{2}^{2} + {c}_{1}^{4} + 2 {c}_{1}^{2} {c}_{2}^{2} + {c}_{2}^{4} ) = 4 {α}^{2} {T}_{p}^{4} - 4 {α}^{2} {T}_{p}^{2} {c}_{1}^{2} - 4 {T}_{p}^{2} {c}_{2}^{2} + 4 {c}_{1}^{2} {c}_{2}^{2}$$

Rearranging the equation results in the following polynomial.

$$( {α}^{4} - 2 {α}^{2} + 1 ) {T}_{p}^{4} + ( - 2 {α}^{2} {F}_{y}^{2} - 2 {F}_{y}^{2} + 2 {α}^{2} {c}_{1}^{2} - 2 {α}^{2} {c}_{2}^{2} - 2 {c}_{1}^{2} + 2 {c}_{2}^{2} ) {T}_{p}^{2} + ( {F}_{y}^{4} + 2 {F}_{y}^{2} {c}_{1}^{2} + 2 {F}_{y}^{2} {c}_{2}^{2} + {c}_{1}^{4} - 2 {c}_{1}^{2} {c}_{2}^{2} + {c}_{2}^{4} ) = 0$$

The roots of a 4^{th} order polynomial without odd terms can be found using a modified version of the quadratic equation.

$$A {T}_{p}^{4} + B {T}_{p}^{2} + C = 0$$

$${T}_{p} = \pm \sqrt{\frac{- B \pm \sqrt{{B}^{2} - 4 A C}}{2 A}}$$

Solving for the port thrust results in four potential solutions, any one of which could be valid depending on the force/moment command vector. All four potential solutions can be used to calculate four potential port and starboard angles. The angles can also be positive or negative, resulting in eight potential combinations of solutions. The eight potential solutions can be entered into the original kinematic equations, and the one that produces the correct force/moment command vector can be used for subsequent calculations.

Class 5: Port Thrust equal to Starboard Thrust times the ratio of the max thrust limit to the minimum thrust limit

FIG. 13 shows an illustrative example comprising a subspace of the “workspace” of FIG. 6B, corresponding to “Class 5.” The fifth classification is defined by the port thrust being equal to the starboard thrust times the ratio of the maximum forward thrust (Tmax) to the maximum reverse thrust (Tmin). This class has a subspace volume that occupies 15.0% of the total workspace for the prior example. As determined by the classifier, this class reaches the surface of the total workspace for one thrust limit: when the starboard thrust is equal to the maximum propulsion device positive thrust (Tmax) and the port thrust is equal to the maximum propulsion device negative thrust (Tmin).

$$[ \begin{matrix}{F}_{x} \\ {F}_{y} \\ \frac{( {M}_{z} + {F}_{y} X )}{Y}\end{matrix} ] = [ \begin{matrix}α {T}_{s} cos ( {ϕ}_{p} ) + {T}_{s} cos ( {ϕ}_{s} ) \\ α {T}_{s} sin ( {ϕ}_{p} ) + {T}_{s} sin ( {ϕ}_{s} ) \\ - α {T}_{s} cos ( {ϕ}_{p} ) + {T}_{s} cos ( {ϕ}_{s} )\end{matrix} ]$$

Using the first and third equations, the following equations for the two angles are found as a function of the starboard thrust Tₛ.

$${ϕ}_{p} = {cos}^{- 1} ( \frac{( {F}_{x} - \frac{( {M}_{z} + {F}_{y} X )}{Y} )}{2 α {T}_{s}} )$$

$${ϕ}_{s} = {cos}^{- 1} ( \frac{( {F}_{x} + ( {M}_{z} + {F}_{y} X ) / Y )}{2 {T}_{s}} )$$

Substituting the two angles in the Fy equation results in one equation with one unknown for the starboard thrust.

$${F}_{y} = α {T}_{s} \sqrt{1 - {( \frac{( {F}_{x} - \frac{( {M}_{z} + {F}_{y} X )}{Y} )}{2 α {T}_{s}} )}^{2}} + {T}_{s} \sqrt{1 - {( \frac{( {F}_{x} + \frac{( {M}_{z} + {F}_{y} X )}{Y} )}{2 {T}_{s}} )}^{2}}$$

To condense the solution, the following constants can be defined.

$${c}_{1} = \frac{( {F}_{x} - \frac{( {M}_{z} + {F}_{y} X )}{Y} )}{2}$$

$${c}_{2} = \frac{( {F}_{x} + \frac{( {M}_{z} + {F}_{y} X )}{Y} )}{2}$$

Squaring the equation once and rearranging results in the following equation.

$${F}_{y}^{2} - ( {α}^{2} {T}_{s}^{2} - {c}_{1}^{2} ) - ( {T}_{s}^{2} - {c}_{2}^{2} ) = 2 \sqrt{( {α}^{2} {T}_{s}^{2} - {c}_{1}^{2} ) ( {T}_{s}^{2} - {c}_{2}^{2} )}$$

Squaring this equation results in the following expression.

$$( {α}^{4} + 2 {α}^{2} + 1 ) {T}_{s}^{4} + ( - 2 {α}^{2} {F}_{y}^{2} - 2 {F}_{y}^{2} - 2 {α}^{2} {c}_{1}^{2} - 2 {α}^{2} {c}_{2}^{2} - 2 {c}_{1}^{2} - 2 {c}_{2}^{2} ) {T}_{s}^{2} + ( {F}_{y}^{4} + 2 {F}_{y}^{2} {c}_{1}^{2} + 2 {F}_{y}^{2} {c}_{2}^{2} + {c}_{1}^{4} + 2 {c}_{1}^{2} {c}_{2}^{2} + {c}_{2}^{4} ) = 4 {α}^{2} {T}_{s}^{4} - 4 {α}^{2} {T}_{s}^{2} {c}_{1}^{2} - 4 {T}_{s}^{2} {c}_{2}^{2} + 4 {c}_{1}^{2} {c}_{2}^{2}$$

Rearranging the equation results in the following polynomial.

$$( {α}^{4} - 2 {α}^{2} + 1 ) {T}_{s}^{4} + ( - 2 {α}^{2} {F}_{y}^{2} - 2 {F}_{y}^{2} - 2 {α}^{2} {c}_{1}^{2} + 2 {α}^{2} {c}_{2}^{2} + 2 {c}_{1}^{2} - 2 {c}_{2}^{2} ) {T}_{s}^{2} + ( {F}_{y}^{4} + 2 {F}_{y}^{2} {c}_{1}^{2} + 2 {F}_{y}^{2} {c}_{2}^{2} + {c}_{1}^{4} - 2 {c}_{1}^{2} {c}_{2}^{2} + {c}_{2}^{4} ) = 0$$

The roots of a 4^{th} order polynomial without odd terms can be found using a modified version of the quadratic equation.

$${AT}_{s}^{4} + {BT}_{s}^{2} + C = 0$$

$${T}_{s} = \pm \sqrt{\frac{- B \pm \sqrt{{B}^{2} - 4 AC}}{2 A}}$$

Solving for the starboard thrust results in four potential solutions, any one of which could be valid depending on the force/moment command vector. All four potential solutions can be used to calculate four potential port and starboard angles. The angles can also be positive or negative, resulting in eight potential combinations of solutions. The eight potential solutions can be entered into the original kinematic equations and the one that produces the correct force/moment command vector can be used for all subsequent calculations.

In addition to the five classes that define volume of the total workspace, there are five additional classes that can be defined. Three of these additional classes correspond to commands that may occur for common maneuvers, such as moving purely in the surge, sway, or yaw directions. Two of the additional classes correspond to fault mitigation, such as when the port or starboard propulsion devices are malfunctioning.

### Class 6: Port Steering Angle Equal to Starboard Steering Angle (Parallel Steer)

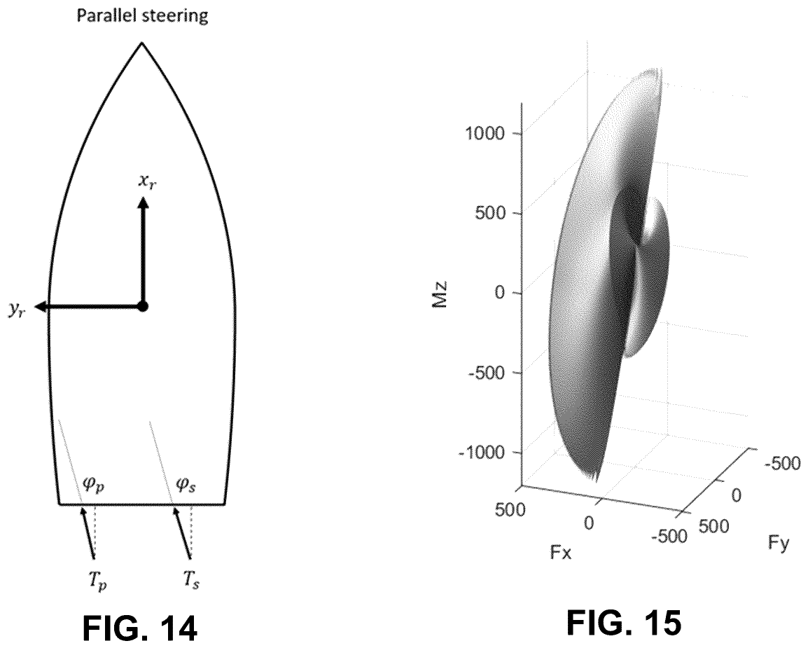

FIG. 14 illustrates generally a set of definitions showing propulsion devices, thrust magnitudes, and thrust angles associated with a parallel steer class definition.

FIG. 15 shows an illustrative example comprising a subspace of the “workspace” of FIG. 6B, corresponding to “Class 6.” The sixth classification is defined by the port steering angle being equal to starboard steering angle. Although this class does not produce force/moment vectors that are on the surface of the total workspace, this class could be used for surge-only motion and would produce smoother, more efficient vessel navigation in certain situations. This class may be selected by the control system when the force/moment command is within the total workspace.

For this class, the forward kinematic equations can be simplified. Note that the input forces Fₓ, F_{y}, M_{z} and the vessel configuration X, and Y are considered known values for this derivation. The port and starboard steering angles are equal and defined as φₚₛ.

$$[ \begin{matrix}{F}_{x} \\ {F}_{y} \\ \frac{( {M}_{z} + {F}_{y} X )}{Y}\end{matrix} ] = [ \begin{matrix}{T}_{p} cos ( {ϕ}_{ps} ) + {T}_{s} cos ( {ϕ}_{ps} ) \\ {T}_{p} sin ( {ϕ}_{ps} ) + {T}_{s} sin ( {ϕ}_{ps} ) \\ - {T}_{p} cos ( {ϕ}_{ps} ) + {T}_{s} cos ( {ϕ}_{ps} )\end{matrix} ] = [ \begin{matrix}( {T}_{p} + {T}_{s} ) cos ( {ϕ}_{ps} ) \\ ( {T}_{p} + {T}_{s} ) sin ( {ϕ}_{ps} ) \\ ( - {T}_{p} + {T}_{s} ) cos ( {ϕ}_{ps} )\end{matrix} ]$$

Using the first and second equations, the following equation for the common steering angle, φₚₛ, can be found.

$${ϕ}_{ps} = {tan}^{- 1} \frac{{F}_{y}}{{F}_{x}}$$

Using the first and third equation, allow for the starboard and port thrusts to be calculated, using the calculated steering angle.

$${T}_{s} = \frac{( {F}_{x} + \frac{( {M}_{z} + {F}_{y} X )}{Y} )}{( 2 cos ( {ϕ}_{ps} ) )}$$

$${T}_{p} = \frac{( {F}_{x} - \frac{( {M}_{z} + {F}_{y} X )}{Y} )}{( 2 cos ( {ϕ}_{ps} ) )}$$

$${ϕ}_{p} = {ϕ}_{ps}$$

$${ϕ}_{s} = {ϕ}_{ps}$$

### Class 7: Port Steering Angle Equal to the Negative of Starboard Steering Angle (Counter Steer)

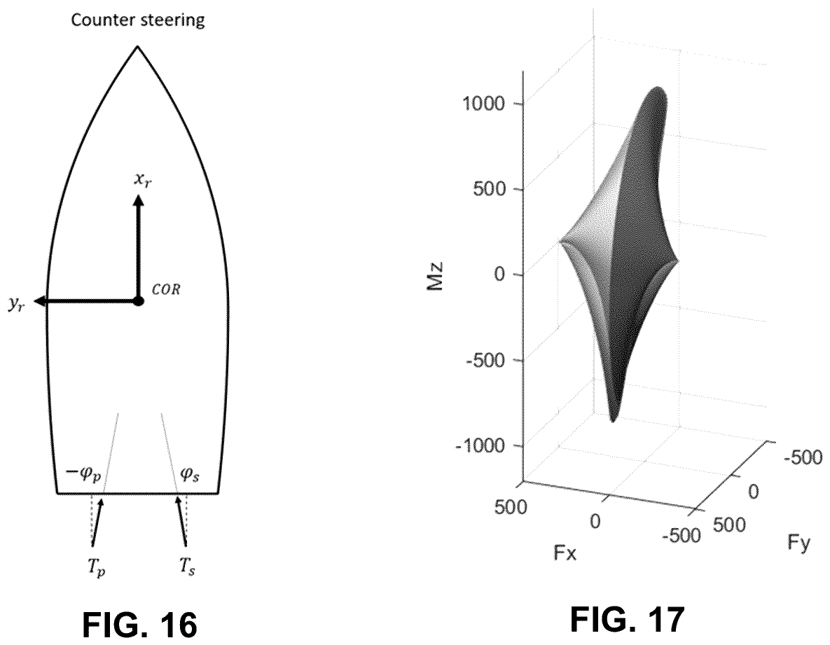

FIG. 16 illustrates generally a set of definitions showing propulsion devices, thrust magnitudes, and thrust angles associated with a counter steer class definition.

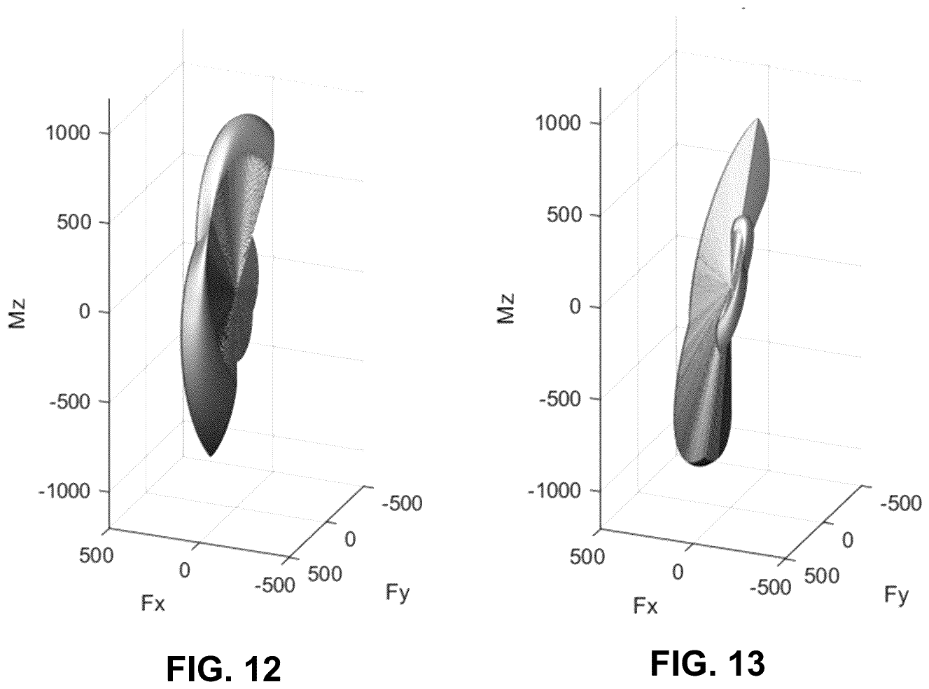

FIG. 17 shows an illustrative example comprising a subspace of the “workspace” of FIG. 6B, corresponding to “Class 7.” The seventh classification is defined by the port steering angle being equal to the negative of the starboard steering angle. Although this class does not produce force/moment vectors that are on the surface of the total workspace, this class could be used for sway-only motion and would produce smoother, more efficient vessel navigation in certain situations. This class may be selected by the control system when the force/moment command is within the total workspace. For this class, the forward kinematic equations can be simplified. Note that the input forces Fₓ, F_{y}, M_{z} and the vessel configuration X, and Y are considered known values for this derivation. The port and starboard steering angles are equal and defined as φ_{cs}.

$$[ \begin{matrix}{F}_{x} \\ {F}_{y} \\ \frac{( {M}_{z} + {F}_{y} X )}{Y}\end{matrix} ] = [ \begin{matrix}{T}_{p} cos ( - {ϕ}_{cs} ) + {T}_{s} cos ( {ϕ}_{cs} ) \\ {T}_{p} sin ( - {ϕ}_{cs} ) + {T}_{s} sin ( {ϕ}_{cs} ) \\ - {T}_{p} cos ( - {ϕ}_{cs} ) + {T}_{s} cos ( {ϕ}_{cs} )\end{matrix} ] = [ \begin{matrix}( {T}_{p} + {T}_{s} ) cos ( {ϕ}_{cs} ) \\ ( - {T}_{p} + {T}_{s} ) sin ( {ϕ}_{cs} ) \\ ( - {T}_{p} + {T}_{s} ) cos ( {ϕ}_{cs} )\end{matrix} ]$$

Using the second and third equations, the following equation for the counter steering angle, φ_{cs}, can be found.

$${ϕ}_{cs} = {tan}^{- 1} \frac{{F}_{y}}{\frac{( {M}_{z} + {F}_{y} X )}{Y}}$$

Using the first and third equation, along with the equation for the counter steering angle, the starboard and port thrusts to be calculated. The port and starboard steering angles are defined by the counter steering angle.

$${T}_{s} = \frac{( {F}_{x} + \frac{( {M}_{z} + {F}_{y} X )}{Y} )}{( 2 cos ( {ϕ}_{cs} ) )}$$

$${T}_{p} = \frac{( {F}_{x} - \frac{( {M}_{z} + {F}_{y} X )}{Y} )}{( 2 cos ( {ϕ}_{cs} ) )}$$

$${ϕ}_{p} = - {ϕ}_{cs}$$

$${ϕ}_{s} = {ϕ}_{cs}$$

### Class 8: Port Thrust Equal to the Negative of Starboard Thrust (Counter Thrust)

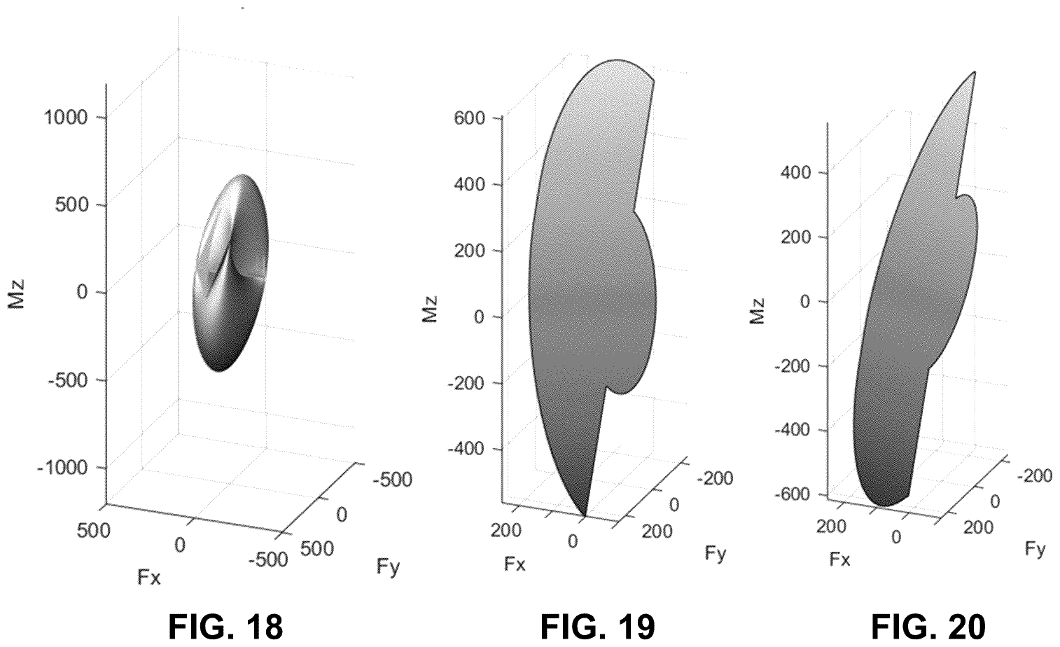

FIG. 18 shows an illustrative example comprising a subspace of the “workspace” of FIG. 6B, corresponding to “Class 8.” The eighth classification is defined by the port thrust being equal to the negative of the starboard thrust. Although this class does not produce force/moment vectors that are on the surface of the total workspace, this class could be used for yaw-only motion and may produce smoother, more efficient vessel navigation in certain situations. This class may be selected by the control system when the force/moment command is within the total workspace.

For this class, the forward kinematic equations can be simplified. Note that the input forces Fₓ, F_{y}, M_{z} and the vessel configuration X, and Y are considered known values for this derivation.

$$[ \begin{matrix}{F}_{x} \\ {F}_{y} \\ \frac{( {M}_{z} + {F}_{y} X )}{Y}\end{matrix} ] = [ \begin{matrix}- {T}_{s} cos ( - {ϕ}_{p} ) + {T}_{s} cos ( {ϕ}_{s} ) \\ - {T}_{s} sin ( - {ϕ}_{p} ) + {T}_{s} sin ( {ϕ}_{s} ) \\ {T}_{s} cos ( - {ϕ}_{p} ) + {T}_{s} cos ( {ϕ}_{s} )\end{matrix} ]$$

Using the first and third equations, the following equations for the two angles are found as a function of the starboard thrust Tₛ.

$$\begin{matrix}{ϕ}_{p} = - {cos}^{- 1} ( \frac{( {F}_{x} - \frac{( {M}_{z} + {F}_{y} X )}{Y} )}{- 2 {T}_{s}} ) \\ {ϕ}_{s} = {cos}^{- 1} ( \frac{( {F}_{x} + \frac{( {M}_{z} + {F}_{y} X )}{Y} )}{2 {T}_{s}} )\end{matrix}$$

Substituting the two angles in the Fy equation results in one equation with one unknown for the common thrust.

$${F}_{y} = - {T}_{s} \sqrt{1 - {( \frac{( {F}_{x} - \frac{( {M}_{z} + {F}_{y} X )}{Y} )}{2 {T}_{s}} )}^{2}} + {T}_{s} \sqrt{1 - {( \frac{( {F}_{x} + \frac{( {M}_{z} + {F}_{y} X )}{Y} )}{2 {T}_{s}} )}^{2}}$$

To condense the solution, the following constants can be defined.

$$\begin{matrix}{c}_{1} = \frac{( {F}_{x} - \frac{( {M}_{z} + {F}_{y} X )}{Y} )}{2} \\ {c}_{2} = \frac{( {F}_{x} + \frac{( {M}_{z} + {F}_{y} X )}{Y} )}{2}\end{matrix}$$

Squaring the equation once and rearranging results in the following equation.

$${F}_{y}^{2} - ( {T}_{s}^{2} - {c}_{1}^{2} ) - ( {T}_{s}^{2} - {c}_{2}^{2} ) = - 2 \sqrt{( {T}_{s}^{2} - {c}_{1}^{2} ) ( {T}_{s}^{2} - {c}_{2}^{2} )}$$

Squaring this equation results in the following expression.

$$\begin{matrix}{T}_{s}^{4} + ( - 4 {F}_{y}^{2} - 4 {c}_{1}^{2} - 4 {c}_{2}^{2} ) {T}_{s}^{2} + ( {F}_{y}^{4} + 2 {F}_{y}^{2} {c}_{1}^{2} + 2 {F}_{y}^{2} {c}_{2}^{2} + {c}_{1}^{4} + 2 {c}_{1}^{2} {c}_{2}^{2} + {c}_{2}^{4} ) \\ = 4 {T}_{s}^{4} - 4 {T}_{p}^{2} {c}_{1}^{2} - 4 {T}_{p}^{2} {c}_{2}^{2} + 4 {c}_{1}^{2} {c}_{2}^{2}\end{matrix}$$

The simplified express is shown below.

$${F}_{y}^{4} + 2 {F}_{y}^{2} {c}_{1}^{2} + 2 {F}_{y}^{2} {c}_{2}^{2} + {c}_{1}^{4} - 2 {c}_{1}^{2} {c}_{2}^{2} + {c}_{2}^{4} = 4 {F}_{y}^{2} {T}_{s}^{2}$$

Since there is only one term with Tₛ, the thrust value can be solved as shown below. The thrust can be positive or negative depending on the force/moment vector command.

$${T}_{s} = \pm \sqrt{\frac{{( {c}_{1}^{2} + {c}_{2}^{2} - {F}_{y}^{2} )}^{2} - 4 {c}_{1}^{2} {c}_{2}^{2}}{4 {F}_{y}^{2}}}$$

Knowing the thrust value, the magnitude of the two angles can be found using the previously defined equations. The signs of the angles and thrust can be determined by checking each combination of positive and negative values and selecting the combination that matches the force/moment vector command.

### Class 9: Port Thrust Equal to Zero (Fault 1—No Port Side Propulsion)

FIG. 19 shows an illustrative example comprising a subspace of the “workspace” of FIG. 6B, corresponding to “Class 9.” The ninth classification is defined by the port thrust being equal to zero. This class would only be used if the port side propulsion devices were malfunctioning. In the event of a port side propulsion fault, this mode would allow the vessel to successfully navigate with reduced functionality. This class would only be used if a port propulsion fault was detected that required the port thrusters to be deactivated. Having this class allows the vessel to continue to navigate, even with a propulsion fault.

The forward kinematic equations are shown below. Since there are only two propulsion variables and three equations, it is not possible to satisfy all three elements in the force/moment command vector.

$$[ \begin{matrix}{F}_{x} \\ {F}_{y} \\ {M}_{z}\end{matrix} ] = [ \begin{matrix}{T}_{s} cos ( {ϕ}_{s} ) \\ {T}_{s} sin ( {ϕ}_{s} ) \\ - {T}_{s} sin ( - {ϕ}_{s} ) X + {T}_{s} cos ( {ϕ}_{s} ) Y\end{matrix} ] = [ \begin{matrix}{T}_{s} cos ( {ϕ}_{s} ) \\ {T}_{s} sin ( {ϕ}_{s} ) \\ - {F}_{y} X + {F}_{x} Y\end{matrix} ]$$

Since the propulsion system only has two variables, the subspace for the class is represented by a flat plane, which can be defined mathematically.

The input force/moment command vector is projected onto the plane to find a feasible force/moment command that is closest to the original target values. The modified force/moment command vector can represent the target force/moment command vector minus the unit vector that defines the plane of the subspace times the scale distance from the force/moment vector to the surface of the plane.

$$[ \begin{matrix}{\tilde{F}}_{x} \\ {\tilde{F}}_{y} \\ {\tilde{M}}_{z}\end{matrix} ] = [ \begin{matrix}{F}_{x} \\ {F}_{y} \\ {M}_{z}\end{matrix} ] - k \hat{n}$$

Knowing that the modified force/moment command vector is on the plane, the two command vectors can be found.

$$\begin{matrix}{ϕ}_{s} = {tan}^{- 1} ( \frac{{\tilde{F}}_{y}}{{\tilde{F}}_{x}} ) \\ {T}_{s} = \frac{{\tilde{F}}_{x}}{cos ( {ϕ}_{s} )}\end{matrix}$$

### Class 10: Starboard Thrust Equal to Zero (Fault 2—No Starboard Side Propulsion)

FIG. 20 shows an illustrative example comprising a subspace of the “workspace” of FIG. 6B, corresponding to “Class 10.” The tenth classification is defined by the starboard thrust being equal to zero. This class would only be used if the starboard side propulsion devices were malfunctioning. In the event of a starboard side propulsion fault, this mode would allow the vessel to successfully navigate to base, where the device could be inspected and repaired. This class would only be used if a starboard propulsion fault was detected that required the starboard thrusts to be deactivated. Having this class allows the vessel to continue to navigate, even with a propulsion fault.

$$[ \begin{matrix}{F}_{x} \\ {F}_{y} \\ {M}_{z}\end{matrix} ] = [ \begin{matrix}{T}_{p} cos ( {ϕ}_{p} ) \\ {T}_{p} sin ( {ϕ}_{p} ) \\ - {T}_{p} sin ( - {ϕ}_{p} ) X + {T}_{p} cos ( {ϕ}_{p} ) Y\end{matrix} ] = [ \begin{matrix}{T}_{p} cos ( {ϕ}_{p} ) \\ {T}_{p} sin ( {ϕ}_{p} ) \\ - {F}_{y} X - {F}_{x} Y\end{matrix} ]$$

Since the propulsion system only has two variables, the subspace for the class can be represented by a flat plane, which can be defined mathematically.

The input force/moment command vector is projected onto the plane to find a feasible force/moment command that is closest to the original target values. The modified force/moment command vector can represent the target force/moment command vector minus the unit vector that defines the plane of the subspace times the scale distance from the force/moment vector to the surface of the plane.

$$[ \begin{matrix}{\tilde{F}}_{x} \\ {\tilde{F}}_{y} \\ {\tilde{M}}_{z}\end{matrix} ] = [ \begin{matrix}{F}_{x} \\ {F}_{y} \\ {M}_{z}\end{matrix} ] - k \hat{n}$$

Knowing that the modified force/moment command vector is on the plane, the two command vectors can be found.

$$\begin{matrix}{ϕ}_{s} = {tan}^{- 1} ( \frac{{\tilde{F}}_{y}}{{\tilde{F}}_{x}} ) \\ {T}_{s} = \frac{{\tilde{F}}_{x}}{cos ( {ϕ}_{s} )}\end{matrix}$$

When there are multiple feasible solutions from different operating classes, the technique described herein can implement a cost function to evaluate each feasible solution and select the one meeting a specified criterion (e.g., minimum cost). This approach can be used to evaluate trade-offs between energy efficiency, component durability, and transient response of the actuators, as illustrative examples. There are multiple ways to formulate the cost function, and the desired cost function may vary depending on the vessel task or other objectives.

For example, if a force/moment command was 100N of thrust in the surge direction with zero sway and yaw moment, multiple operating classes can produce feasible solutions. For example, one approach might involve directing all propulsion devices straight ahead (parallel steer class) and applying a total thrust force of 100N. Another feasible solution would be rotating the thrusters inward at a 60-degree counter-steer angle (counter steer class) and applying a total thrust force of 200N. Both solutions achieve the desired thrust, but the latter consumes more energy.

To select the optimal solution, a cost function can be employed. One criterion within this function could prioritize minimizing the sum of the motor forces required. Other considerations might involve reducing steering actuator movements, ensuring operational smoothness by minimizing abrupt changes in thruster direction, and other considerations. Below is an example of a cost function that factors in the magnitude of port and starboard thrusts, as well as changes in proposed steering angles relative to current angles for each feasible class:

The following is an illustrative example of a cost function:

$$cost = {a}_{1} {T}_{p}^{2} + {a}_{2} {T}_{s}^{2} + {{a}_{3} ( {ϕ}_{p , proposed} - {ϕ}_{p , current} )}^{2} + {{a}_{4} ( {ϕ}_{s , proposed} - {ϕ}_{s , current} )}^{2}$$

The aᵢ coefficients are tunable. By tuning these coefficients, the cost function can effectively balance different objectives such as energy efficiency, maneuver smoothness, and operational effectiveness based on a vessel current state and mission requirements.

Generally, the present subject matter illustrates techniques and systems that can be used for controlling marine vessels, such as those equipped with multiple independently steered propulsion devices. Such subject matter can provide precise management of vessel position, orientation, and velocity through advanced control techniques. The present approach can begin by receiving commands to achieve specific position, velocity, and orientation, referred to collectively as a vessel state. Based on these commands and the current state of the vessel, the present subject matter can be used to establish an appropriate operating mode, which can involve pose control, path following, or a transitional state. The present subject matter can determine a target force/moment vector using feedback control, including saturating the force/moment vector to the feasible workspace. The present subject matter can result in identification of many feasible solutions when possible, for the propulsion device commands, and the present subject matter can be used for selection of an optimal propulsion command vector such as guided by a cost function.

### Other Examples

The taxonomy defined above involving ten classes is merely illustrative and other classification schemes can be used to partition a workspace of potential force and moment combinations, based on different vessel configurations or constraints. For example, if angular constraints for thruster actuation azimuths (e.g., steering angle limits) are allowed to be limited to less than or equal to ninety degrees, 28 distinct operating classes can be established, broadly grouped into distinct saturation patterns for a two-thruster vessel:
(1) TT: Both thrust magnitudes at a limit;
(2) TA: One thrust limit and one steering-angle limit; and
(3) TA-0: One Thrust Limit and one steering-angle is zero degrees.

For the USV of FIG. 3, and as an illustrative example, thruster variables and locations are shown in TABLE 3.

TABLE 3
Illustrative Examples of Marine Surface
Vessel Thruster Variables and Location

| Quantity | Symbol | Value (nominal) |
|---|---|---|
| Maximum forward thrust (per thruster) | T_{f, max} | 250N |
| Maximum reverse thrust (per thruster) | T_{t, max} | −100N |
| Longitudinal offset from CoR* | X | 1 m (variable) |
| Transverse offset from CoR* | Y | 1 m (variable) |
| Steering-angle limit | φₘₐₓ | ±90° |
| | | (hardware) |

*Chosen as X = Y = 1 m for the baseline study; both remain user-tunable.

The 28 potential operating classes grouped by saturation pattern are shown below in TABLE 4.

TABLE 4
Potential operating classes grouped by saturation pattern.
Dual-thrust saturation (TT)

| | | |
|---|---|---|
| Tₚ(max) & Tₛ(max) | Tₚ(max) & Tₛ(min) | Tₚ(min) & Tₛ(max) |
| Tₚ(min) & Tₛ(min) | | |

Mixed saturation (TA)

| | | |
|---|---|---|
| Tₚ(max) & φₚ(max) | Tₚ(max) & φₚ(min) | Tₚ(min) & φₚ(max) |
| Tₚ(min) & φₚ(min) | Tₛ(max) & φₛ(max) | Tₛ(max) & φₛ(min) |
| Tₛ(min) & φₛ(max) | Tₛ(min) & φₛ(min) | Tₚ(max) & φₛ(max) |
| Tₚ(max) & φₛ(min) | Tₚ(min) & φₛ(max) | Tₚ(min) & φₛ(min) |
| Tₛ(max) & φₚ(max) | Tₛ(max) & φₚ(min) | Tₛ(min) & φₚ(max) |
| Tₛ(min) & φₚ(min) | | |

TA-0: one thrust limit, one centre-line angle

| | | |
|---|---|---|
| Tₚ(max) & φₚ(0) | Tₚ(min) & φₚ(0) | Tₛ(max) & φₛ(0) |
| Tₛ(min) & φₛ(0) | Tₚ(max) & φₛ(0) | Tₚ(min) & φₛ(0) |
| Tₛ(max) & φₚ(0) | Tₛ(min) & φₚ(0) | |

For any steering limit φ̅ₘₐₓ<90° with asymmetric thrust bounds (Tf_{,max}, T_{r,max})=(250, 100) N, only sixteen of the twenty-eight operating classes of TABLE 4 are ever selected. These sixteen classes, shown below in TABLE 5, fall into just five algebraically identical families (categories of classes), and can be handled by a corresponding closed-form inverse routine.

TABLE 5
Sixteen active classes and corresponding analytic solver families

| Family | Classes (active limits) |
|---|---|
| TT | Tₛ(max) & Tₚ(max) |
| | Tₛ(min) & Tₚ(min) |
| | Tₛ(min) & Tₚ(max) |
| | Tₛ(max) & Tₚ(min) |
| TsAs-0 | Tₛ(max) & φₛ(0) |
| | Tₛ(min) & φₛ(0) |
| TpAp-0 | Tₚ(max) & φₚ(0) |
| | Tₚ(min) & φₚ(0) |
| TsAp | Tₛ(max) & φₚ(max) |
| | Tₛ(max) & φₚ(min) |
| | Tₛ(min) & φₚ(max) |
| | Tₛ(min) & φₚ(min) |
| TpAs | Tₚ(max) & φₛ(max) |
| | Tₚ(max) & φₛ(min) |
| | Tₚ(min) & φₛ(max) |
| | Tₚ(min) & φₛ(min) |

The five analytic solver families can be identified as follows: TT (both thrusts known, dual-thrust saturation); TpAs (port thrust and starboard angle known, mixed saturation); TsAp (starboard thrust and port angle known, mixed saturation); TpAp-0 (port thrust known and port angle zero); and TsAs-0 (starboard thrust known and starboard angle zero). Although the sixteen active operating classes identified above can each be inverted analytically, the regions they occupy in the workspace overlap once the force magnitude drops below Rₘₐₓ. A naive classifier would therefore have to trial every candidate class (or every solver family) until a feasible solution is found, potentially wasting computation and introducing a data-dependent latency. A decision-tree classifier can be used to eliminate this overhead by pre-partitioning the (Fₓ, F_{y}, M_{z}) workspace with analytical boundaries derived from 2-D projections, for a series of 26 boolean “feasibility checks,” arranged hierarchically. For example, at run time commanded force and moment values can be routed down a fixed sequence of simple sign tests and scalar inequalities, deterministically selecting exactly one operating class or flagging the command as infeasible if it lies outside the attainable set. This hierarchical screening approach (i) provides mutual exclusivity among classes even in the overlap zones, so no redundant solver calls are made; (ii) bounds the worst-case computational cost to O(1) (e.g., a few dozen floating-point operations), satisfying a high-speed, real-time capability of the controller; and (iii) provides a clear mapping between physical operating constraints (e.g., thrust and steering limits) and the software logic that enforces them. In general, the decision tree approach turns a library of closed-form inverse solutions into a predictable, low-latency allocation scheme suited to embedded implementation. If the actuator steering angle limit is set to ninety degrees exactly (rather than to a value less than or equal to ninety degrees), the operating classes further collapse to a scheme similar to those discussed above elsewhere in this document.

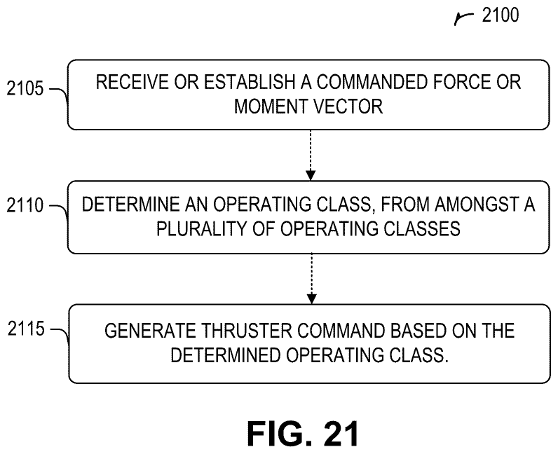

FIG. 21 illustrates generally a technique 2100, such a machine implemented method, for performing marine vessel control. At 2105, a commanded force or moment vector can be received or established. For example, as shown and described elsewhere herein, a user can specify a commanded force or moment vector (e.g., including a force or a moment, or both a force and a moment), which is then transmitted to a controller for use in controlling the vessel. In another example, a higher-level control system can generate the commanded force or moment vector based on a specified trajectory or other objective. At 2110, an operating class can be determined from amongst a plurality of operating classes, such as based on a constraint combination of steerable thruster variables. The determined operating class can be selected to achieve the commanded force or moment vector (where achieve does not necessarily mean exactly matching the commanded values but can include controlling the vessel in such a manner as to drive the relevant force or moment toward the commanded values). Such constraints and potential categories or groups of operating classes are discussed above, and such determination can include a variety of approaches, such as, for example, use of a decision tree or cost function analysis, or other approaches. At 2115 thruster commands can be generated, such as for steerable thrusters, based on the determined operating class. The technique 2100 can include scaling thrust values or otherwise constraining the generated thruster commands (including steering actuator angle) to satisfy physical limitations in thrust values or steering angle range while still driving vessel behavior toward the commanded force or moment vector.

FIG. 22 illustrates a block diagram of an example comprising a machine 2200 upon which any one or more of the techniques (e.g., methodologies) discussed herein may be performed. Such a machine 2200 can be in communication with a vessel or located on or within a vessel to perform control. Machine 2200 (e.g., computer system) may include a hardware processor 2202 (e.g., a central processing unit (CPU), a graphics processing unit (GPU), a hardware processor core, or any combination thereof), a main memory 2204 and a static memory 2206, connected via an interlink 2230 (e.g., link or bus), as some or all of these components may constitute hardware for systems or related implementations discussed above.

Generally, the hardware processor 2202 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 2204 include Random Access Memory (RAM), and semiconductor memory devices, which may include storage locations in semiconductors such as registers. Specific examples of static memory 2206 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 2200 may further include a display device 2210, an input device 2212 (e.g., a keyboard), and a user interface (UI) navigation device 2214 (e.g., a mouse). In an example, the display device 2210, input device 2212, and UI navigation device 2214 may be a touch-screen display. The machine 2200 may include a mass storage device 2208 (e.g., drive unit), a signal generation device 2218 (e.g., a speaker), a network interface device 2220, and one or more sensors 2216, such as a global positioning system (GPS) sensor, compass, accelerometer, or some other sensor. The machine 2200 may include an output controller 2228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 2208 may comprise a machine-readable medium 2222 on which is stored one or more sets of data structures or instructions 2224 (e.g., software) embodying or utilized by any one or more of the techniques or functions described herein. The instructions 2224 may also reside, completely or at least partially, within the main memory 2204, within static memory 2206, or within the hardware processor 2202 during execution thereof by the machine 2200. In an example, one or any combination of the hardware processor 2202, the main memory 2204, the static memory 2206, or the mass storage device 2208 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 2224.

An apparatus of the machine 2200 includes one or more of a hardware processor 2202 (e.g., a central processing unit (CPU), a graphics processing unit (GPU), a hardware processor core, or any combination thereof), a main memory 2204 and a static memory 2206, sensors 2216, network interface device 2220, antennas, a display device 2210, an input device 2212, a UI navigation device 2214, a mass storage device 2208, instructions 2224, a signal generation device 2218, or an output controller 2228. The apparatus may be configured to perform one or more of the methods or operations disclosed herein.

The term “machine readable medium” includes, for example, any medium that is capable of storing, encoding, or carrying instructions for execution by the machine 2200 and that cause the machine 2200 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 2224 may be transmitted or received, for example, over a communications network 2226 using a transmission medium via the network interface device 2220 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 2220 includes one or more physical jacks (e.g., Ethernet, coaxial, or other interconnection) or one or more antennas to access the communications network 2226. In an example, the network interface device 2220 includes one or more antennas to wirelessly communicate using at least one of single-input multiple-output (SIMO), multiple-input multiple-output (MIMO), or multiple-input single-output (MISO) techniques. In some examples, the network interface device 2220 wirelessly communicates using Multiple User MIMO techniques. The term “transmission medium” shall be taken to include any intangible medium that is capable of storing, encoding or carrying instructions for execution by the machine 2200, and includes digital or analog communications signals or other intangible medium to facilitate communication of such software.

### Various Notes

Each of the non-limiting examples below can stand on its own or can be combined in various permutations or combinations with one or more of the other examples or other subject matter described in this document.

Example 1 comprises a machine-implemented method for controlling a marine vessel using steerable thrusters that can include receiving or establishing a commanded force or moment vector, determining an operating class from amongst a plurality of operating classes based on constraint combinations of steerable thruster variables that achieves the commanded force or moment vector, and generating thruster commands for the steerable thrusters based on the determined operating class.

In Example 2, the machine-implemented method of Example 1 can include that the commanded force or moment vector includes one or more of a surge force, a sway force, or a yaw moment for the marine vessel.

In Example 3, the machine-implemented method of any of Examples 1 or 2 can include selecting an operating mode from a plurality of operating modes including a pose control mode and a path following mode, and establishing the commanded force or moment vector based at least in part on the operating mode.

In Example 4, the machine-implemented method of Example 3 can include that selecting the operating mode is based on comparing a current vessel state to a desired vessel state.

In Example 5, the machine-implemented method of any of Examples 1 through 4 can include that the plurality of operating classes includes respective classes based on saturating at least two of the steerable thruster variables at their respective limits.

In Example 6, the machine-implemented method of any of Examples 1 through 5 can include that generating thruster commands comprises evaluating a closed-form inverse kinematic model corresponding to a determined operating class.

In Example 7, the machine-implemented method of any of Examples 1 through 6 can include that the steerable thrusters comprise a port thruster and a starboard thruster located on or nearby opposite sides of the marine vessel.

In Example 8, the machine-implemented method of Example 7 can include that the port thruster and the starboard thruster are independently controllable using the steerable thruster variables, the steerable thruster variables comprising at least one of a thrust magnitude, a steering angle, or both a thrust magnitude and a steering angle.

In Example 9, the machine-implemented method of any of Examples 1 through 8 can include that the plurality of operating classes fall within a locus of force and moment combinations defining a workspace representing achievable force and moment combinations within physical limits of steerable thruster variables.

In Example 10, the machine-implemented method of Example 9 can include scaling the commanded force or moment vector when the commanded force or moment vector exceeds a workspace boundary.

In Example 11, the machine-implemented method of any of Examples 1 through 10 can include that determining the operating class comprises selecting an operating class that produces a maximum achievable force magnitude in a direction corresponding to the commanded force or moment vector.

In Example 12, the machine-implemented method of any of Examples 1 through 11 can include that the plurality of operating classes comprises steering configurations corresponding to at least two different steering categories comprising parallel steering, counter steering, or blended steering.

In Example 13, the machine-implemented method of any of Examples 1 through 12 can include that determining the operating class comprises using a decision tree classifier to evaluate feasibility conditions corresponding to the plurality of operating classes.

In Example 14, the machine-implemented method of Example 13 can include that the decision tree classifier uses boolean feasibility checks arranged hierarchically to determine the operating class.

In Example 15, the machine-implemented method of any of Examples 1 through 14 can include that the plurality of operating classes comprises at least two different categories of classes comprising dual-thrust saturation classes, mixed saturation classes, or zero angle classes.

Example 16 comprises a marine vessel control system for controlling a marine vessel using steerable thrusters that can include a controller comprising a processor circuit and a memory circuit, the memory circuit comprising instructions that when executed by the processor circuit, cause the controller to receive or establish a commanded force or moment vector, determine an operating class from amongst a plurality of operating classes based on constraint combinations of steerable thruster variables that achieves the commanded force or moment vector, and generate control signals for the steerable thrusters based on the determined operating class.

In Example 17, the marine vessel control system of Example 16 can include that the commanded force or moment vector includes one or more of a surge force, a sway force, or a yaw moment for the marine vessel.

In Example 18, the marine vessel control system of any of Examples 16 or 17 can include that the plurality of operating classes include respective classes based on saturating at least two of the steerable thruster variables at their respective limits.

In Example 19, the marine vessel control system of any of Examples 16 through 18 can include where the controller is configured to generate control signals by evaluating a closed-form inverse kinematic model corresponding to a determined operating class.

In Example 20, the marine vessel control system of any of Examples 16 through 19 can include where the steerable thrusters comprise a port thruster and a starboard thruster located on or nearby opposite sides of the marine vessel.

In Example 21, the marine vessel control system of Example 20 can include where the port thruster and the starboard thruster are independently controllable using thruster variables comprising at least one of a thrust magnitude, a steering angle, or both a thrust magnitude and a steering angle.

In Example 22, the marine vessel control system of any of Examples 16 through 21 can include that the plurality of operating classes fall within a locus of force and moment combinations defining a workspace representing achievable force and moment combinations within physical limits of steerable thruster variables.

In Example 23, the marine vessel control system of Example 22 can include that the instructions comprise instructions that cause the controller to scale the commanded force or moment vector when the commanded force or moment vector exceeds a workspace boundary.

In Example 24, the marine vessel control system of any of Examples 16 through 23 can include that the instructions comprise instructions that cause the controller to determine the operating class by selecting an operating class that produces a maximum achievable force magnitude in a direction corresponding to the commanded force or moment vector.

In Example 25, the marine vessel control system of any of Examples 16 through 24 can include that the plurality of operating classes comprises steering configurations corresponding to at least two different steering categories comprising parallel steering, counter steering, or blended steering.

In Example 26, the marine vessel control system of any of Examples 16 through 25 can include that the instructions comprise instructions that cause the controller to use a decision tree classifier to evaluate feasibility conditions corresponding to the plurality of operating classes.

In Example 27, the marine vessel control system of Example 26 can include that the decision tree classifier uses boolean feasibility checks arranged hierarchically to determine the operating class.

In Example 28, the marine vessel control system of any of Examples 16 through 27 can include where the plurality of operating classes comprises at least two different categories of classes comprising dual-thrust saturation classes, mixed saturation classes, or zero angle classes.

Example 29 comprises a marine vessel controllable using steerable thrusters that can include the steerable thrusters, a sensor configured to measure a current state of the marine vessel, and a controller comprising a processor circuit and a memory circuit, the memory circuit comprising instructions that when executed by the processor circuit, cause the controller to select an operating mode from a plurality of operating modes based on comparing the current state of the marine vessel to a desired vessel state and establishing a commanded force or moment vector based at least in part on the operating mode, determine an operating class from amongst a plurality of operating classes based on constraint combinations of steerable thruster variables that achieves the commanded force or moment vector, and generate control signals for the steerable thrusters based on the determined operating class.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A machine-implemented method for controlling a marine vessel using steerable thrusters, the machine-implemented method comprising:
receiving or establishing a commanded force or moment vector;
determining an operating class, from amongst a plurality of operating classes based on constraint combinations of steerable thruster variables, that achieves the commanded force or moment vector; and
generating thruster commands for the steerable thrusters based on the determined operating class.

2. The machine-implemented method of claim 1, wherein the commanded force or moment vector includes one or more of a surge force, a sway force, or a yaw moment for the marine vessel.

3. The machine-implemented method of claim 1, comprising:
selecting an operating mode from a plurality of operating modes including a pose control mode and a path following mode; and
establishing the commanded force or moment vector based at least in part on the operating mode.

4. The machine-implemented method of claim 3, wherein selecting the operating mode is based on comparing a current vessel state to a desired vessel state.

5. The machine-implemented method of claim 1, wherein the plurality of operating classes includes respective classes based on saturating at least two of the steerable thruster variables at their respective limits.

6. The machine-implemented method of claim 1, wherein generating thruster commands comprises evaluating a closed-form inverse kinematic model corresponding to a determined operating class.

7. The machine-implemented method of claim 1, wherein the steerable thrusters comprise a port thruster and a starboard thruster located on or nearby opposite sides of the marine vessel.

8. The machine-implemented method of claim 7, wherein the port thruster and the starboard thruster are independently controllable using the steerable thruster variables, the steerable thruster variables comprising at least one of a thrust magnitude, a steering angle, or both a thrust magnitude and a steering angle.

9. The machine-implemented method of claim 1, wherein the plurality of operating classes fall within a locus of force and moment combinations defining a workspace representing achievable force and moment combinations within physical limits of steerable thruster variables.

10. The machine-implemented method of claim 9, comprising scaling the commanded force or moment vector when the commanded force or moment vector exceeds a workspace boundary.

11. The machine-implemented method of claim 1, wherein determining the operating class comprises selecting an operating class that produces a maximum achievable force magnitude in a direction corresponding to the commanded force or moment vector.

12. The machine-implemented method of claim 1, wherein the plurality of operating classes comprises steering configurations corresponding to at least two different steering categories comprising: parallel steering, counter steering, or blended steering.

13. The machine-implemented method of claim 1, wherein determining the operating class comprises using a decision tree classifier to evaluate feasibility conditions corresponding to the plurality of operating classes.

14. The machine-implemented method of claim 13, wherein the decision tree classifier uses boolean feasibility checks arranged hierarchically to determine the operating class.

15. The machine-implemented method of claim 1, wherein the plurality of operating classes comprises at least two different categories of classes comprising: dual-thrust saturation classes, mixed saturation classes, or zero angle classes.

16. A marine vessel control system for controlling a marine vessel using steerable thrusters, the marine vessel control system comprising:
a controller comprising a processor circuit and a memory circuit, the memory circuit comprising instructions that when executed by the processor circuit, cause the controller to:
receive or establish a commanded force or moment vector;
determine an operating class from amongst a plurality of operating classes based on constraint combinations of steerable thruster variables that achieves the commanded force or moment vector; and
generate control signals for the steerable thrusters based on the determined operating class.

17. The marine vessel control system of claim 16, wherein the commanded force or moment vector includes one or more of a surge force, a sway force, or a yaw moment for the marine vessel.

18. The marine vessel control system of claim 16, wherein the plurality of operating classes include respective classes based on saturating at least two of the steerable thruster variables at their respective limits.

19. The marine vessel control system of claim 16, wherein the controller is configured to generate control signals by evaluating a closed-form inverse kinematic model corresponding to a determined operating class.

20. The marine vessel control system of claim 16, wherein the steerable thrusters comprise a port thruster and a starboard thruster located on or nearby opposite sides of the marine vessel.

21. The marine vessel control system of claim 20, wherein the port thruster and the starboard thruster are independently controllable using thruster variables comprising at least one of a thrust magnitude, a steering angle, or both a thrust magnitude and a steering angle.

22. The marine vessel control system of claim 16, wherein the plurality of operating classes fall within a locus of force and moment combinations defining a workspace representing achievable force and moment combinations within physical limits of steerable thruster variables.

23. The marine vessel control system of claim 22, wherein the instructions comprise instructions that cause the controller to scale the commanded force or moment vector when the commanded force or moment vector exceeds a workspace boundary.

24. The marine vessel control system of claim 16, wherein the instructions comprise instructions that cause the controller to determine the operating class by selecting an operating class that produces a maximum achievable force magnitude in a direction corresponding to the commanded force or moment vector.

25. The marine vessel control system of claim 16, wherein the plurality of operating classes comprises steering configurations corresponding to at least two different steering categories comprising: parallel steering, counter steering, or blended steering.

26. The marine vessel control system of claim 16, wherein the instructions comprise instructions that cause the controller to use a decision tree classifier to evaluate feasibility conditions corresponding to the plurality of operating classes.

27. The marine vessel control system of claim 26, wherein the decision tree classifier uses boolean feasibility checks arranged hierarchically to determine the operating class.

28. The marine vessel control system of claim 16, wherein the plurality of operating classes comprises at least two different categories of classes comprising: dual-thrust saturation classes, mixed saturation classes, or zero angle classes.

29. A marine vessel controllable using steerable thrusters, the marine vessel comprising:
the steerable thrusters;
a sensor configured to measure a current state of the marine vessel; and
a controller comprising a processor circuit and a memory circuit, the memory circuit comprising instructions that when executed by the processor circuit, cause the controller to:
select an operating mode from a plurality of operating modes based on comparing the current state of the marine vessel to a desired vessel state, and establishing a commanded force or moment vector based at least in part on the operating mode;
determine an operating class from amongst a plurality of operating classes based on constraint combinations of steerable thruster variables that achieves the commanded force or moment vector; and
generate control signals for the steerable thrusters based on the determined operating class.
